(19) United States
(12) Patent Application Publication
(10) Pub. No.: US 2025/0088596 A1
(43) Pub. Date: Mar. 13, 2025

(54) IMAGE PROCESSING APPARATUS, SERVER, SYSTEM, CONTROLLING METHOD AND STORAGE MEDIUM THEREFOR

(71) Applicant: CANON KABUSHIKI KAISHA, Tokyo (JP)

(72) Inventor: Yoko Takenaka, Chiba (JP)

(21) Appl. No.: 18/963,336

(22) Filed: Nov. 27, 2024

Related U.S. Application Data
(63) Continuation of application No. 17/745,654, filed on May 16, 2022.

(30) Foreign Application Priority Data
May 19, 2021 (JP) 2021-084785

(51) Int. Cl. H04N 1/00; H04N 1/44

(52) U.S. Cl. CPC H04N 1/00501; H04N 1/00217; H04N 1/00244; H04N 1/00464; H04N 1/00933; H04N 1/4413; H04N 1/4426

(57) ABSTRACT

An image processing apparatus transmits a request to a content server at a specific timing such as login, logout, auto-clear, print start. The image processing apparatus receives contents provided from the content server in response to the request, and displays the contents in an operation unit. If a user operating the image processing apparatus is specified by user authentication, the image processing apparatus adds information of the user to the request, and receives the content modified by the content server according to the information of the user from the content server and displays the modified contents.

### CROSS-REFERENCE TO RELATED APPLICATIONS

This application is a Continuation of U.S. patent application Ser. No. 17/745,654, filed May 16, 2022, which claims the benefit of Japanese Patent Application No. 2021-084785, filed May 19, 2021, both of which are hereby incorporated by reference herein in their entirety.

### BACKGROUND

### Field of the Disclosure

The present disclosure relates to an image processing apparatus, a server, a system, a control method and a storage medium therefor.

### Description of the Related Art

In recent years, the “digital signage” which transmits information outdoors, in stores, in public spaces, in public transportation, and elsewhere using display devices connected to networks, has been spreading.

The use of digital signage is also attracting attention in offices of companies for the purpose of supporting information sharing among employees and controlling information of companies.

The street signage is used to display advertisements for promotion to unspecified many users. On the other hand, image processing apparatuses used in offices or the like preferably display contents depending on users using the image processing apparatuses.

Japanese Patent Application Laid-Open No. 2013-542796 proposes a technology that enables a content server to provide content depending on users by creating response data to clients based on a source address of an HTTP request and a description of an HTTP header. According to Japanese Patent Application Laid-Open No. 2013-542796, a location of the user is specified by the source address, the characteristics of the user (for example, a language in which communication is possible) are specified by an HTTP header (description of “Accept-Language”), and the contents are returned depending on the users.

However, in an environment where a single device is used by multiple users such as an image processing apparatus, the source address and the HTTP header are described in common, and it is impossible to specify individual users from the information. Therefore, in the prior art such as Japanese Patent Application Laid-Open No. 2013-542796, there is an issue that contents cannot be provided in accordance with users in an environment in which a single apparatus is used by multiple users such as an image processing apparatus.

### SUMMARY

The above issues can be solved by embodiments of the present disclosure. According to embodiments of the present disclosure, a mechanism is provided that allows to display contents depending on users using a device in an environment where multiple users use a single device.

According to embodiments of the present disclosure, an information processing apparatus is operable to communicate with a server providing contents, and the information processing apparatus comprises: at least one processor; and at least one memory coupled to the at least one processor and storing instructions, which when executed by the at least one processor, cause the at least one processor to act as: a first setting unit configured to set timing of displaying contents; a controller configured to: transmit a request for the contents to the server; receive the contents provided from the server based on the request; and display the contents on an operation unit at the set timing; and an identifying unit configured to identify a user operating the information processing apparatus, wherein the controller is further configured to add information of the user identified by the identifying unit to the request.

Further features of the present disclosure will become apparent from the following description of exemplary embodiments with reference to the attached drawings.

### BRIEF DESCRIPTION OF THE DRAWINGS

FIG. 1 shows the overall configuration of an image processing system according to the present embodiment.

FIG. 2 is a block diagram showing the configuration of the image processing apparatus according to the present embodiment.

FIG. 3 shows a software configuration diagram of the overall system including the image processing apparatus of the present embodiment.

FIG. 4A is a flowchart showing a content display process according to the first embodiment.

FIG. 4B is a flowchart showing a content display process according to the first embodiment.

FIG. 4C is a flowchart showing a content display process according to the first embodiment.

FIG. 4D is a flowchart showing a content display process according to the first embodiment.

FIG. 4E is a flowchart showing a content display process according to the first embodiment.

FIG. 4F is a flowchart showing a content display process according to the first embodiment.

FIG. 5A is a diagram showing a content setting screen according to the present embodiment.

FIG. 5B is a diagram showing a content setting screen according to the present embodiment.

FIG. 5C is a diagram showing a content setting screen according to the present embodiment.

FIG. 5D is a diagram showing a content setting screen according to the present embodiment.

FIG. 5E is a diagram showing a content setting screen according to the present embodiment.

FIG. 5F is a diagram showing a content setting screen according to the present embodiment.

FIG. 5G is a diagram showing a content setting screen according to the present embodiment.

FIG. 6 is a diagram showing a content setting management table according to the present embodiment.

FIG. 7A is a diagram showing a setting screen for user authentication according to the embodiment.

FIG. 7B is a diagram showing a setting screen for user authentication according to the embodiment.

FIG. 7C is a diagram showing a setting screen for user authentication according to the embodiment.

FIG. 7D is a diagram showing a setting screen for user authentication according to the embodiment.

FIG. 8 is a diagram showing a screen when contents are displayed on the operation unit in this embodiment.

FIG. 9A is a diagram showing the transition of the screen displayed in the operation unit according to the embodiment.

FIG. 9B is a diagram showing the transition of the screen displayed in the operation unit according to the embodiment.

FIG. 9C is a diagram showing the transition of the screen displayed in the operation unit according to the embodiment.

FIG. 9D is a diagram showing the transition of the screen displayed in the operation unit according to the embodiment.

FIG. 9E is a diagram showing the transition of the screen displayed in the operation unit according to the embodiment.

FIG. 10 is a diagram showing an error screen displayed in the operation unit according to the present embodiment.

FIG. 11 is a diagram showing a content error management table according to the present embodiment.

FIG. 12 is a diagram showing an HTTP request sent by the image processing apparatus to the content server according to the present embodiment.

FIG. 13 shows an HTTP response sent by the content server to the image processing apparatus according to the present embodiment.

FIG. 14 is a diagram showing a screen when contents depending on users are displayed according to the present embodiment.

FIG. 15 is a diagram showing a content management table managed by the content server according to the present embodiment.

FIG. 16A shows a flowchart for describing the content displaying process according to the second embodiment.

FIG. 16B shows a flowchart for describing the content displaying process according to the second embodiment.

FIG. 17A shows a flowchart for describing the content displaying process according to the third embodiment.

FIG. 17B shows a flowchart for describing the content displaying process according to the third embodiment.

FIG. 17C shows a flowchart for describing the content displaying process according to the third embodiment.

FIG. 18 is a diagram showing a content management table managed by the content server according to the third embodiment.

FIG. 19 is a diagram showing an HTTP response sent by the content server to the image processing apparatus according to the present embodiment.

FIG. 20A shows a flowchart for describing the content displaying process according to the fourth embodiment.

FIG. 20B shows a flowchart for describing the content displaying process according to the fourth embodiment.

FIG. 21 is a diagram showing a content management table managed by the image processing apparatus according to the fourth embodiment.

### DESCRIPTION OF THE EMBODIMENTS

### First Embodiment

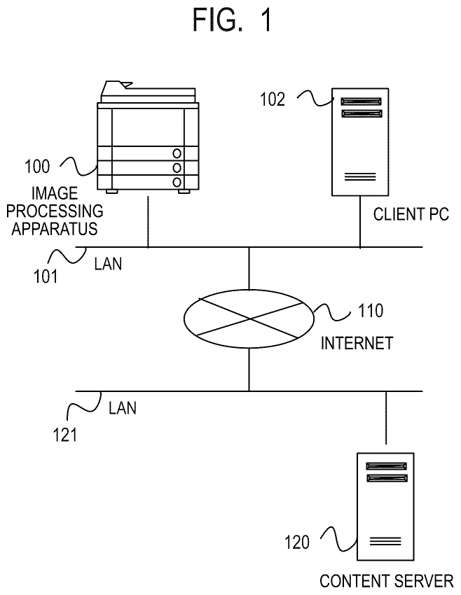

The first embodiment of the present disclosure will now be described with reference to FIGS. 1 to 15.

FIG. 1 shows the overall configuration of an image processing system according to the present embodiment.

As shown in FIG. 1, an image processing apparatus 100 is connected to an Internet 110 via an LAN 101. A client PC 102 can be connected to the image processing apparatus 100 via the LAN 101. A content server 120 stores various contents, is connected to the Internet 110 via an LAN 121, and can provide the contents to the image processing apparatus 100.

The image processing apparatus 100 can communicate with the content server 120 via the Internet 110, and can obtain contents described later by requesting the content server 120.

Here, the image processing apparatus 100, the client PC 102, and the content server 120 are described as an example, but multiple apparatuses may be used. Alternatively, instead of the content server 120, the content may be stored in the image processing apparatus 100, and the content may be acquired and displayed internally.

The content server 120 may be implemented by a single computer or multiple computers. For example, the content server 120 may be implemented using a cloud service.

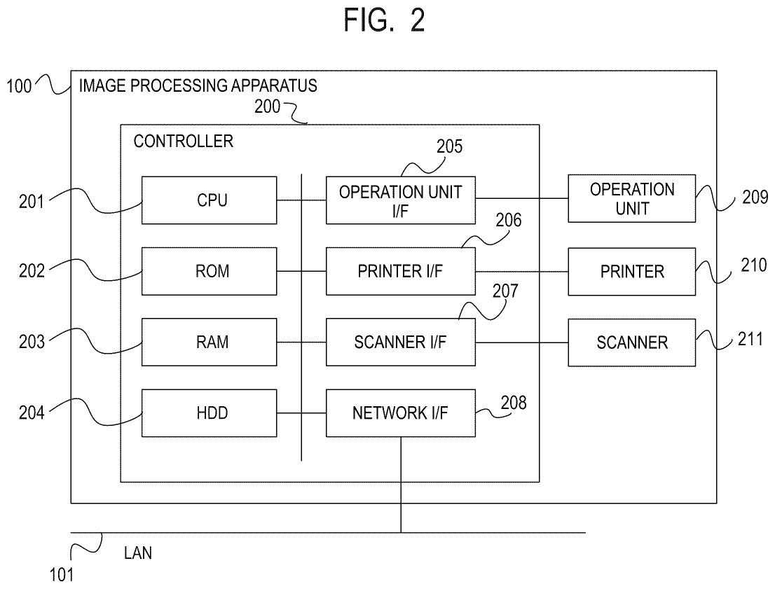

FIG. 2 is a block diagram showing the configuration of the image processing apparatus according to the present embodiment.

A controller 200 including a CPU 201 controls the operation of the overall image processing apparatus 100. The CPU 201 reads a control program stored in a ROM 202 and performs various controls such as print control, read-in control, transmission control, and content display control that is described later. A ROM 202 is a boot ROM and stores a boot program of the system. A RAM 203 is used as a main memory of the CPU 201 and a temporary storage area such as a work area. An HDD (Hard Disk Drive) 204 stores image data, various programs, and various information tables. The HDD 204 can also store contents that are described later. The HDD 204 may be replaced with another storage device such as an SSD (Solid State Drive).

An operation unit interface 205 connects an operation unit 209 and the controller 200. The operation unit 209 is provided with a liquid crystal display having a touch panel function and a keyboard.

A printer interface 206 connects a printer 210 and the controller 200. The image data to be printed by the printer 210 is transferred from the controller 200 via the printer interface 206 and printed on a recording medium (paper or the like) by the printer 210.

A scanner interface 207 connects a scanner 211 and the controller 200. The scanner 211 reads an image on a printout or a manuscript to generate image data, and inputs the generated image data to the controller 200 via the scanner interface 207.

A network I/F 208 is an interface for connecting the controller 200 to the LAN 101. The network I/F 208 transmits or receives information to an external device connected to the Internet 110 via the LAN 101.

The image processing apparatus 100 has several functions (applications), such as copying, printing, scanning and transmitting, scanning and saving, using saved files, and browsing. Hereinafter, these representative functions will be described.

The “copying” is a function for printing, by using the printer 210, image data generated by the scanner 211 reading an image on a printout or a manuscript.

The “printing” is a function for printing image data by the printer 210 based on a print job input from an outside device such as the client PC 102.

The “scanning and transmitting” is a function for transmitting image data generated by the scanner 211 reading an image on a printout or a manuscript to the outside via the network I/F 208.

The “scanning and saving” is a function for saving, to the HDD 204, image data generated by the scanner 211 reading an image on a printout or a manuscript.

The “using saved files” is a function for printing image data stored in the HDD 204 by the printer 210 or transmitting the image data to the outside via the network I/F 208.

The “browsing” is a function for browsing, printing and storing data on a web server through a Web browser.

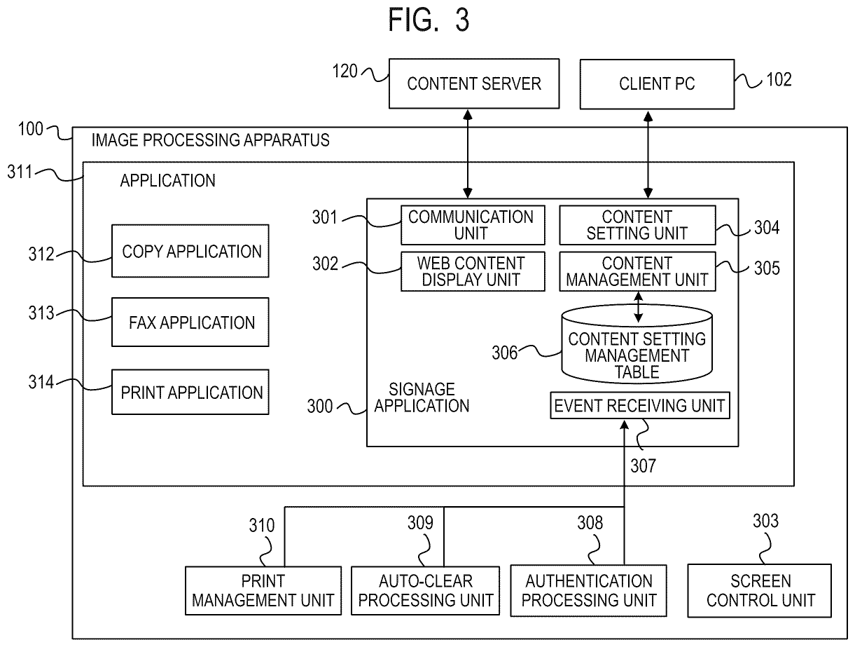

FIG. 3 shows a software configuration diagram of the overall system including the image processing apparatus of the present embodiment. Each unit shown in FIG. 3 is implemented by the CPU 201 in the image processing apparatus 100 reading and executing the control program stored in the ROM 202 or the HDD 204.

The image processing apparatus 100 has a software configuration of an application 311, a screen control unit 303, an authentication processing unit 308, an auto-clear processing unit 309, and a print management unit 310.

The application 311 includes a signage application 300, a copy application 312, a fax application 313, a print application 314, and the like. The application 311 may include other applications not shown here.

The signage application 300 is an embedded software program included in the image processing apparatus 100. The signage application 300 includes a communication unit 301, a web content display unit 302, a content setting unit 304, a content management unit 305, a content setting management table 306, an event receiving unit 307.

The communication unit 301 communicates with the content server 120 and acquires contents managed by the content server 120 and the content setting management table 306. The communication protocol for communicating between the communication unit 301 and the content server 120 is, for example, SMB, WebDAV, HTTP, or the like. SMB represents Server Message Block. WebDAV represents Web-based Distributed Authoring and Versioning. HTTP represents Hypertext Transfer Protocol. It should be noted that other communication protocols such as e-mail and File Transfer Protocol (FTP) may be used for communications between the communication unit 301 and the content server 120. FTP represents File Transfer Protocol.

The web content display unit 302 reads the content stored in the content server 120 or the HDD 204 into the RAM 203 and outputs the content to the operation unit 209. The content refers to data that can be browsed by a Web browser, such as text data, HTML, image files (JPEG, GIF, PNG, BMP, etc.), and video files.

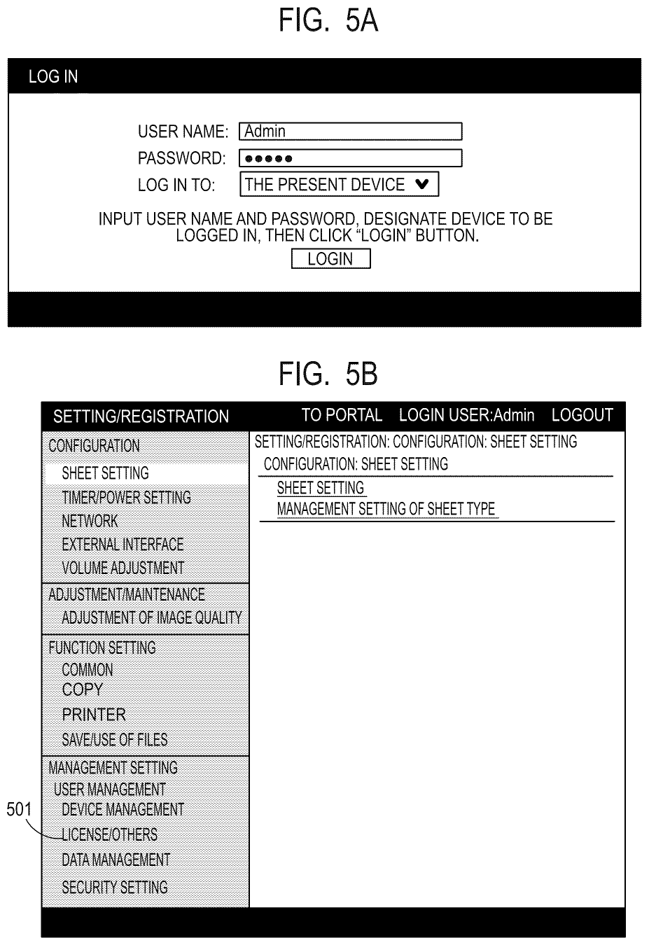

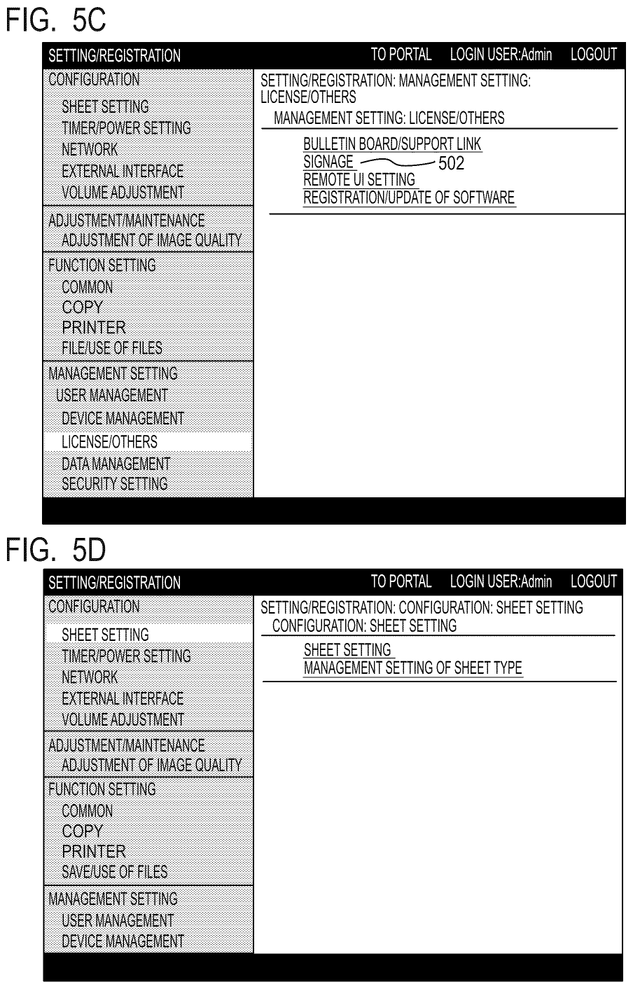

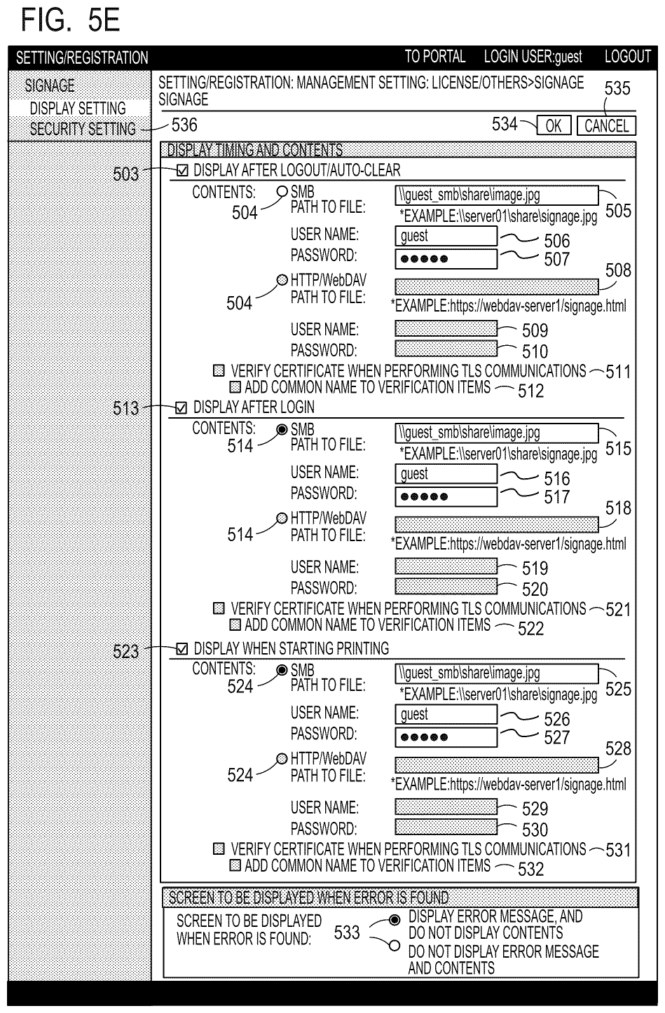

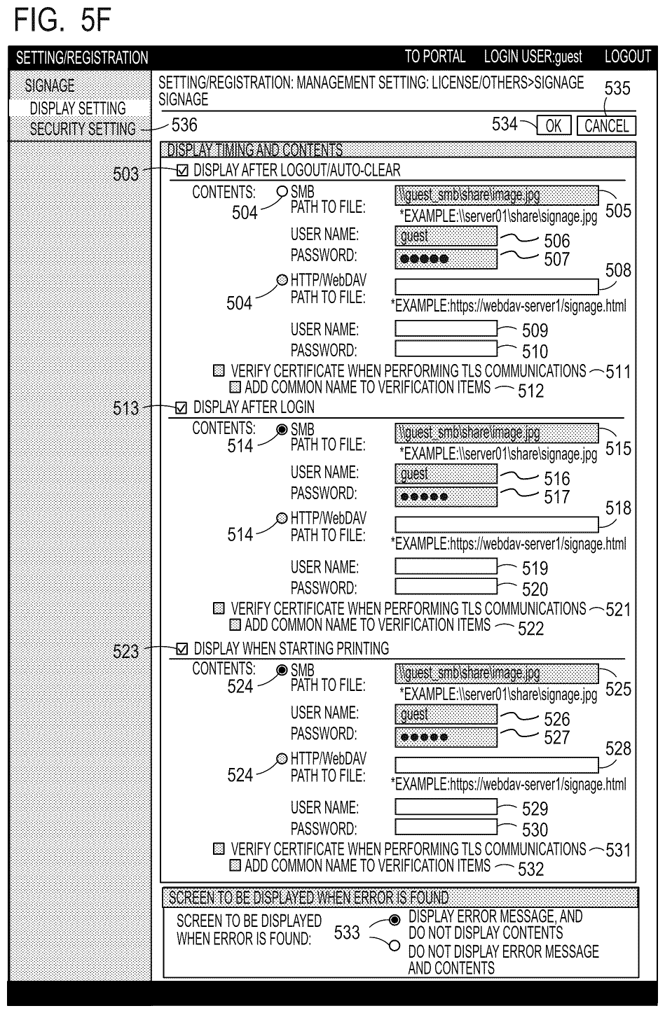

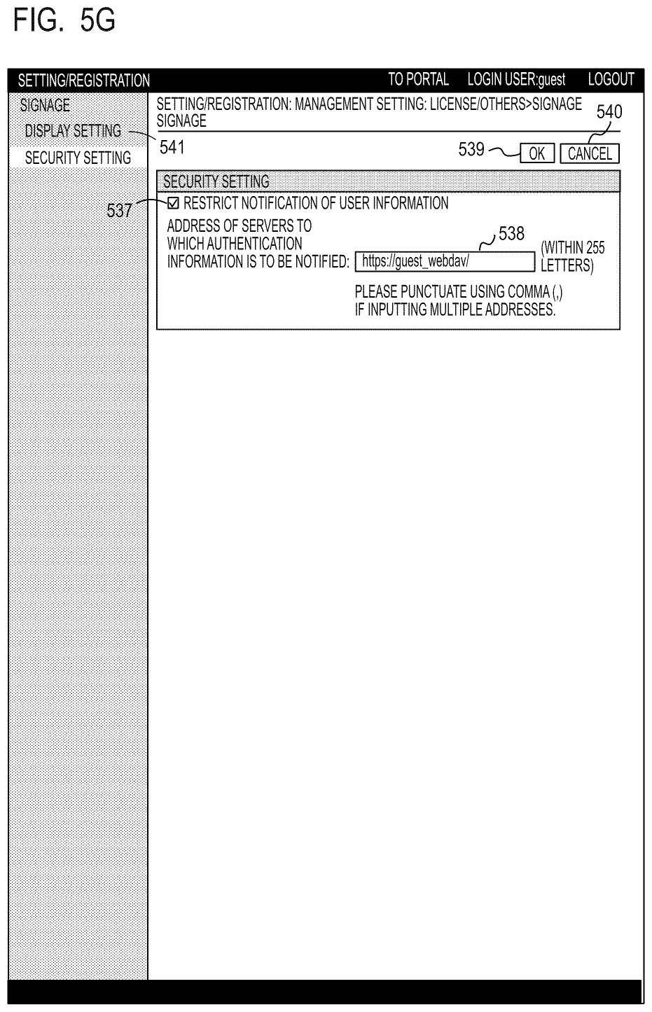

The content setting unit 304 sets the content to be displayed in the operation unit 209 when a specific event occurs. In the present embodiment, the content to be displayed when a specific event occurs can be specified from the client PC 102. The content setting unit 304 sets the content to be displayed when a specific event occurs in the content setting management table 306 through the content management unit 305 based on the setting specified by the client PC 102. Here, a method of the client PC 102 specifying the content to be displayed when a specific event occurs will be specifically described with reference to FIGS. 5A to 5G.

FIGS. 5A to 5G are diagrams showing an example of an authentication screen and a screen for setting contents to be displayed in the operation unit 209 when a specific event occurs.

When the client PC 102 accesses a Web server (not shown) of the image processing apparatus 100 using the Web browser of the client PC 102, an authentication screen as shown in FIG. 5A is displayed on the Web browser of the client PC 102. The authentication screen is also referred to as a “login screen”.

FIG. 5A is a diagram showing a content setting screen according to the present embodiment.

If a user inputs a user name and a password through the authentication screen of FIG. 5A and presses a login button, a login request including the user name and the password is transmitted to the image processing apparatus 100, and the authentication processing unit 308 performs user authentication and login processing. The user authentication may be performed by an external authentication server. Further, the image processing apparatus 100 may be provided with a short-range wireless communication unit (NFC communication unit), an IC card reader, or the like, and an input of information for user authentication (username and password in the example of FIG. 5A) may be performed by reading an NFC or the like of an IC card or a smartphone. In this case, a message prompting user authentication by the IC card, such as “bring the IC card close to a reader for login” is displayed on the authentication screen. The NFC represents “Near Field Communication”.

If the user having the authority as an administrator successfully logs in, the screen shown in FIG. 5B is displayed on the Web browser of the client PC 102 (hereinafter simply referred to as “client PC 102”).

In FIG. 5A, if a user without the authority as an administrator logs in, the screen of FIG. 5D is displayed on the client PC 102.

FIG. 5B is a diagram showing an example of a screen for allowing a user having the authority as an administrator to perform various settings related to the image processing apparatus 100.

If one of setting items is selected from the menu displayed on the left side of the screen, the setting item corresponding to the selected setting item is displayed on the right side of the screen. For example, if the user selects the setting item “License/Other” 501 from the menu on the left side of the screen, the screen shown in FIG. 5C is displayed on the right side of the screen.

FIG. 5C is a diagram showing an example of a screen for performing detailed settings related to the “Licenses/Other” 501.

Each setting item including setting items 502 is a hyperlink, and when selected, a Web page corresponding to the setting item is displayed. If the user selects the setting item “Signage” 502, the setting screen of the signage application 300 shown in FIGS. 5E to 5G is displayed on the client PC 102.

FIG. 5D is a diagram showing an example of a screen for allowing a user who does not have the authority as an administrator to perform various settings related to the image processing apparatus 100.

On this screen, items that can be set only by a user having the authority as an administrator such as the setting item “License/Other” 501 displayed on the screen of FIG. 5B are not displayed. Therefore, a user who does not have the authority as an administrator is not allowed to display setting screens of the signage application 300 shown in FIGS. 5E to 5G. Thus, by displaying the setting screen of the signage application 300 only to the user having the authority as an administrator, the user who can set the content to be displayed when a specific event occurs can be limited to the administrator.

In the present embodiment, the user who can set the content to be displayed when a specific event occurs is limited to the user who has the authority as an administrator for the overall image processing apparatus 100, but a general user who does not have the authority as an administrator may also be allowed to set the content to be displayed. Further, in addition to the authority as an administrator of the overall image processing apparatus 100, an authority as an administrator unique to the signage application 300 may be provided so that only the user having the authority can set the content.

FIGS. 5E to 5G are diagrams showing examples of setting screens of the signage application 300. The setting screens of the signage application 300 include screens for setting display setting items as shown in FIGS. 5E and 5F and a screen for setting security items as shown in FIG. 5G.

In the screens illustrated in FIGS. 5E and 5F, a check box 503 is a setting item for displaying the content when the image processing apparatus 100 is logged out and auto-cleared. If the check box 503 is checked, the content is displayed when a logout or auto-clear event described later occurs. If the check box 503 is not checked, the setting items 504 to 512 described later are shaded and entered in a state in which an input to the items is disable. When the check box 503 is checked, as shown in FIGS. 5E and 5F, items available are displayed and these items are not shaded (that is, an input to these items is available).

A radio button 504 is used for selecting a communication protocol between the communication unit 301 and the content server 120. If the radio button 504 is selected for SMB, as shown in FIG. 5E, the setting items relating to SMB are unshaded and each setting item can be input. If the radio button 504 is selected for HTTP/WebDAV, the setting items related to HTTP/WebDAV are unshaded as shown in FIG. 5F, and each setting item can be input.

A text box 505 is an input field for inputting a path of the content displayed if the communication protocol is set to SMB. The path is a character string indicating the storage location of the content, and in the case of SMB, the computer name, folder name, file name, and the like are indicated by separating them with “¥” or “\” (backslash). The content may be a file stored in the HDD 204 or a file stored in the content server 120.

A text box 506 is an input field for inputting a user name used for accessing the path of the content displayed if the communication protocol is set to SMB. A text box 507 is an input field for inputting a password used for accessing the path of the content displayed if the communication protocol is set to SMB.

A text box 508 is an input field for inputting the path of the content to be displayed if the communication protocol is set to HTTP/WebDAV. In the case of HTTP/WebDAV, the path indicates the computer name and folder name indicating the storage location of the content, as well as a file name, and they are separated by “/” (slash). The content may be a file stored in the HDD 204 or a file stored in the content server 120.

A text box 509 is an input field for inputting a user name to be used for accessing the path of the content displayed if the communication protocol is set to HTTP/WebDAV. A text box 510 is an input field for inputting a password to be used for accessing the path of the content displayed if the communication protocol is set to HTTP/WebDAV.

Check boxes 511 and 512 are setting items for inputting settings for performing encrypted communications if the communication protocol is set to HTTP/WebDAV.

A check box 513 is a setting item for displaying contents during the login operation of the image processing apparatus 100. If the check box 513 is checked, the content is displayed when a login event occurs. If the check box 513 is not checked, the setting items 514 to 522 described later are shaded and entered in a state in which an inputting operation is not available. If the check box 513 is checked, as shown in FIGS. 5E and 5F, items available are displayed in an unshaded state.

A radio button 514 is used for selecting a communication protocol between the communication unit 301 and the content server 120. If the radio button 514 is selected for SMB, as shown in FIG. 5E, the setting items relating to SMB are unshaded and each setting item can be input. If the radio button 514 is selected for HTTP/WebDAV, the setting items related to HTTP/WebDAV are unshaded as shown in FIG. 5F, and each setting item can be input.

A text box 515 is an input field for inputting a path of the content displayed when the communication protocol is set to SMB. The path is a character string indicating the storage location of the content, and in the case of SMB, the computer name, folder name, file name and the like are indicated by separating them with “¥” or “\”. The content may be a file stored in the HDD 204 or a file stored in the content server 120.

A text box 516 is an input field for inputting a user name used for accessing the path of the content displayed if the communication protocol is set to SMB. A text box 517 is an input field for inputting a password used for accessing the path of the content displayed if the communication protocol is set to SMB.

A text box 518 is an input field for inputting the path of the content displayed if the communication protocol is set to HTTP/WebDAV. In the case of HTTP/WebDAV, the path indicates the computer name and folder name indicating the storage location of the content as well as file name, and they are separated by “/”. The content may be a file stored in the HDD 204 or a file stored in the content server 120.

A text box 519 is an input field for inputting a user name used for accessing the path of the content displayed if the communication protocol is set to HTTP/WebDAV. A text box 520 is an input field for inputting a password used for accessing the path of the content displayed if the communication protocol is set to HTTP/WebDAV.

Check boxes 521 and 522 are setting items for inputting settings for performing encrypted communications if the communication protocol is set to HTTP/WebDAV.

A check box 523 is a setting item for displaying contents during printing in the image processing apparatus 100. If the check box 523 is checked, the content is displayed when an event for starting printing occurs. If the check box 523 is not checked, setting items 524 to 532 described later are shaded and entered in a state in which an input to the items is not available. If the check box 523 is checked, as shown in FIGS. 5E and 5F, items available are displayed in an unshaded state.

A radio button 524 is a button for selecting a communication protocol between the communication unit 301 and the content server 120. If the radio button 524 is selected for SMB, as shown in FIG. 5E, the setting items relating to SMB are unshaded and each setting item can be input. If the radio button 524 is selected for HTTP/WebDAV, the setting items related to HTTP/WebDAV are unshaded as shown in FIG. 5F, and each setting item can be input.

A text box 525 is an input field for inputting a path of the content displayed if the communication protocol is set to SMB. The path is a character string indicating the storage location of the content, and in the case of SMB, the computer name, folder name, file name and the like are indicated by separating them with “¥” or “\”. The content may be a file stored in the HDD 204 or a file stored in the content server 120.

A text box 526 is an input field for inputting a user name used for accessing the path of the content displayed if the communication protocol is set to SMB. A text box 527 is an input field for inputting a password used for accessing the path of the content displayed if the communication protocol is set to SMB.

A text box 528 is an input field for inputting the path of the content to be displayed if the communication protocol is set to HTTP/WebDAV. In the case of HTTP/WebDAV, the path indicates the computer name and folder name indicating the storage location of the content as well as file name, and they are separated by “/”. The content may be a file stored in the HDD 204 or a file stored in the content server 120.

A text box 529 is an input field for inputting a user name used for accessing the path of the content displayed if the communication protocol is set to HTTP/WebDAV. A text box 530 is an input field for inputting a password used for accessing the path of the content displayed if the communication protocol is set to HTTP/WebDAV.

Check boxes 531 and 532 are setting items for inputting settings for performing encrypted communications if the communication protocol is set to HTTP/WebDAV.

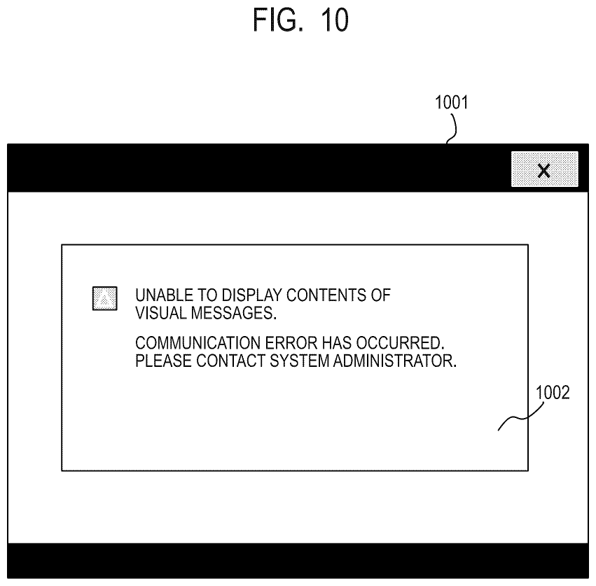

A radio button 533 is a setting item for switching the display ON/OFF of an error screen (the error screen as shown in FIG. 10) to be displayed if an error is detected at the timing of displaying the content. If an item “Display error message, and do not display contents” is selected in the radio button 533, the error screen is displayed in the operation unit 209 when an error is detected at the timing of displaying contents. On the other hand, when an item “Do not display error message and contents” is selected in the radio button 533, the error screen is not displayed in the operation unit 209 when an error is detected at the timing of displaying the content.

An OK button 534 is used for storing the setting inputted in items 503 to 533 in the content setting management table 306 described later. If the OK button 534 is pressed, the content setting unit 304 stores the settings of items 503 to 533 described above in the content setting management table 306 through the content management unit 305, and the screen of the client PC returns to FIG. 5C.

A cancel button 535 is used for returning to the screen of FIG. 5C without storing the setting inputted to the items 503 to 533 in the content setting management table 306.

The multiple check boxes 503, 513, and 523 can be selected. That is, multiple timings for displaying the signage application 300 can be set according to the application.

A security setting button 536 is used for displaying a screen for setting security setting items on the setting screen of the signage application 300. If the security setting button 536 is selected, a screen for setting security items as shown in FIG. 5G is displayed on the client PC 102.

In the screen illustrated in FIG. 5G, a check box 537 is a setting item for setting whether to restrict the user information notification. If the check box 537 is checked, inputting a server address in a text box 538 for permitting the notification becomes possible. In this case, the image processing apparatus 100 compares the address set in the text box 538 with the address of the content server 120. Then, if these match and the content to be displayed by the signage application 300 is HTML, the image processing apparatus 100 gives authentication information obtained at the time of authentication to the header part of the HTML content and notifies the content server 120. Details will be described later. On the other hand, if the address set in the text box 538 does not match the address of the content server 120, the signage application 300 does not notify the content server 120 of the authentication information obtained at the time of authentication. If the check box 537 is not checked, the image processing apparatus 100 gives authentication information obtained at the time of authentication to the header of the HTML content to notify the content server 120.

The control for limiting the user information notification by the security setting shown in FIG. 5G will be described in detail in the second embodiment.

An OK button 539 is used for storing the setting inputted to the items 537 and 538 in the content setting management table 306 described later. If the OK button 539 is pressed, the content setting unit 304 stores the settings inputted to items 537 and 538 described above in the content setting management table 306 through the content management unit 305, and the screen of the client PC returns to FIG. 5C.

A cancel button 540 is used for returning to the screen of FIG. 5C without storing the setting inputted to items 537 and 538 in the content setting management table

A display setting button 541 is used for displaying a screen for setting display setting items on the setting screen of the signage application 300. If the display setting button 541 is selected, screens shown in FIGS. 5E and 5F are displayed on the client PC.

Thus, the user can set and register specific information for specifying the content to be displayed on the signage application 300 via the setting screen shown in FIGS. 5A to 5G. Although the example in which the contents are set from the client PC 102 is shown here, the contents may be set using the operation unit 209 of the image processing apparatus 100.

Hereinafter, the description will return to FIG. 3.

The content management unit 305 stores the content path in the content setting management table 306 based on the setting set by the content setting unit 304. The content management unit 305 acquires the settings stored in the content setting management table 306 and notifies the web content display unit 302.

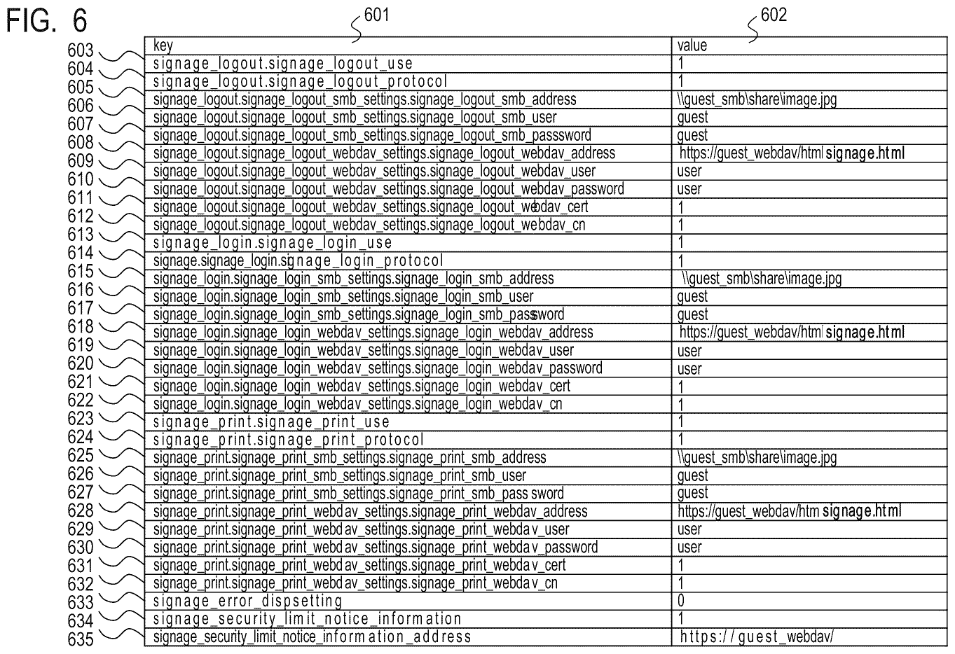

The content setting management table 306 is a management table for managing setting values of the signage application 300 set by the content setting unit 304. The following description will be made with reference to FIG. 6.

FIG. 6 is a diagram showing an example of the content setting management table 306.

The content setting management table 306 shown in FIG. 6 is generated and updated on the basis of the input through the setting screen shown in FIGS. 5E, 5F and 5G. The content setting management table 306 may be stored in the HDD 204 of the image processing apparatus 100 or in the content server 120.

The reference numeral 601 denotes a key corresponding to each setting item of the signage application 300. The reference numeral 602 denotes a value corresponding to a key of each setting item of the signage application 300.

The reference numeral 603 denotes a setting of an item indicating ON/OFF of the screen display of the signage application 300 when a logout or auto-clear operation is performed by the image processing apparatus, where “0” indicates “OFF” and “1” indicates “ON”. If the setting of the check box 503 in FIGS. 5E and 5F is updated, this value is updated.

The reference numeral 604 denotes a setting of an item indicating the communication protocol between the communication unit 301 and the content server 120, where “0” indicates SMB and “1” indicates HTTP/WebDAV. If the setting of the radio button 504 in FIGS. 5E and 5F is updated, this value is updated.

The reference numeral 605 denotes an item indicating the path of the content displayed if the communication protocol is set to SMB. If the setting of the text box 505 in FIGS. 5E and 5F is updated, this value is updated.

The reference numeral 606 denotes a setting of an item indicating a user name used for accessing a path of content displayed if the communication protocol is set to SMB. If the setting of the text box 506 in FIGS. 5E and 5F is updated, this value is updated.

The reference numeral 607 denotes a setting of an item indicating a password used for accessing a path of content displayed if the communication protocol is set to SMB. If the setting of the text box 507 in FIGS. 5E and 5F is updated, this value is updated.

The reference numeral 608 denotes a setting of an item indicating the path of the content displayed if the communication protocol is set to HTTP/WebDAV. If the setting of the text box 508 in FIGS. 5E and 5F is updated, this value is updated.

The reference numeral 609 denotes a setting of an item indicating a user name used for accessing a path of content displayed if the communication protocol is set to HTTP/WebDAV. If the setting of the text box 509 in FIGS. 5E and 5F is updated, this value is updated.

The reference numeral 610 denotes a setting of an item indicating a password used for accessing the path of the content displayed if the communication protocol is set to HTTP/WebDAV. If the setting of the text box 510 in FIGS. 5E and 5F is updated, this value is updated.

The reference numerals 611 and 612 denote setting items indicating settings for performing encrypted communications if the communication protocol is set to HTTP/WebDAV. If the settings of the check boxes 511 and 512 in FIGS. 5E and 5F are updated, these values are updated.

The reference numeral 613 denotes a setting of an item indicating ON/OFF of the screen display of the signage application 300 if the login operation is performed by the image processing apparatus, where “0” indicates OFF and “1” indicates ON. If the setting of the check box 513 in FIGS. 5E and 5F is updated, this value is updated.

The reference numeral 614 denotes a setting of an item indicating the communication protocol between the communication unit 301 and the content server 120, where “0” indicates SMB and “1” indicates HTTP/WebDAV. If the setting of the radio button 514 in FIGS. 5E and 5F is updated, this value is updated.

The reference numeral 615 denotes a setting of an item indicating a path of content displayed if the communication protocol is set to SMB. If the setting of the text box 515 in FIGS. 5E and 5F is updated, this value is updated.

The reference numeral 616 denotes a setting of an item indicating a user name used for accessing a path of content displayed if the communication protocol is set to SMB. If the setting of the text box 516 in FIGS. 5E and 5F is updated, this value is updated.

The reference numeral 617 denotes a setting of an item indicating a password used for accessing a path of content displayed if the communication protocol is set to SMB. If the setting of the text box 517 in FIGS. 5E and 5F is updated, this value is updated.

The reference numeral 618 denotes a setting of an item indicating the path of the content displayed if the communication protocol is set to HTTP/WebDAV. If the setting of the text box 518 in FIGS. 5E and 5F is updated, this value is updated.

The reference numeral 619 denotes a setting of an item indicating a user name used for accessing a path of content displayed if the communication protocol is set to HTTP/WebDAV. If the setting of the text box 519 in FIGS. 5E and 5F is updated, this value is updated.

The reference numeral 620 denotes a setting of an item indicating a password used for accessing the path of the content displayed if the communication protocol is set to HTTP/WebDAV. If the setting of the text box 520 in FIGS. 5E and 5F is updated, this value is updated.

The reference numerals 621 and 622 denote settings for performing encrypted communications if the communication protocol is set to HTTP/WebDAV. If the settings of the check boxes 521 and 522 in FIGS. 5E and 5F are updated, these values are updated.

The reference numeral 623 denotes a setting of an item indicating ON/OFF of the screen display of the signage application 300 at the time of print execution in the image processing apparatus, where “0” indicates OFF and “1” indicates ON. If the setting of the check box 523 in FIGS. 5E and 5F is updated, this value is updated.

The reference numeral 624 denotes a setting of an item indicating a communication protocol between the communication unit 301 and the content server 120, where “0” indicates SMB and “1” indicates HTTP/WebDAV. If the setting of the radio button 524 in FIGS. 5E and 5F is updated, this value is updated.

The reference numeral 625 denotes a setting of an item indicating a path of content displayed if the communication protocol is set to SMB. If the setting of the text box 525 in FIGS. 5E and 5F is updated, this value is updated.

The reference numeral 626 denotes a setting of an item indicating a user name used for accessing a path of content displayed if the communication protocol is set to SMB. If the setting of the text box 526 in FIGS. 5E and 5F is updated, this value is updated.

The reference numeral 627 denotes a setting of an item indicating a password used for accessing a path of content displayed if the communication protocol is set to SMB. If the setting of the text box 527 in FIGS. 5E and 5F is updated, this value is updated.

The reference numeral 628 denotes a setting of an item indicating the path of the content displayed if the communication protocol is set to HTTP/WebDAV. If the setting of the text box 528 in FIGS. 5E and 5F is updated, this value is updated.

The reference numeral 629 denotes a setting of an item indicating a user name used for accessing a path of content displayed if the communication protocol is set to HTTP/WebDAV. If the setting of the text box 529 in FIGS. 5E and 5F is updated, this value is updated.

The reference numeral 630 denotes a setting of an item indicating a password used for accessing the path of the content displayed if the communication protocol is set to HTTP/WebDAV. If the setting of the text box 530 in FIGS. 5E and 5F is updated, this value is updated.

The reference numerals 631 and 632 denote setting items indicating settings for performing encrypted communications if the communication protocol is set to HTTP/WebDAV. If the settings of the check boxes 531 and 532 in FIGS. 5E and 5F are updated, these values are updated.

The reference numeral 633 denotes a setting of an item indicating ON/OFF for displaying an error screen if an error is detected, where “0” indicates “Display error message and do not display contents”, and “1” indicates “Do not display error message and contents”. If the setting of the radio button 533 in FIGS. 5E and 5F is updated, this value is updated.

The reference numeral 634 denotes a setting of an item for setting restriction of notification about the user attribute obtained at the time of authentication of the image processing apparatus to the content server 120, and “0” indicates that the notification is restricted, and “1” indicates that the notification is not restricted. If the setting of the check box 537 in FIG. 5G is updated, this value is updated.

The reference numeral 635 denotes a setting of an item for setting a server address to permit notification if the value of 634 is set to “0”. If the setting of the text box 538 in FIG. 5G is updated, this value is updated.

Hereinafter, the description will return to FIG. 3.

The content management unit 305 obtains the setting value 602 for each setting item by referring to the content setting management table 306 based on the key 601, and notifies the web content display unit 302. The web content display unit 302 acquires the contents stored in the content server 120 or the HDD 204 based on the information notified from the content management unit 305, and displays the contents on the operation unit 209.

In the copy application 312, high-speed and high-quality copying is possible by using a high-resolution scanner and a printer capable of high-speed printing. In the copy application 312, the HDD 204 or the like can be used to copy a large amount of manuscripts by continuous reading. Further, in the copy application 312, the scanned image data can be transmitted to multiple image processing apparatuses via a network to perform the copying by using multiple apparatuses.

The fax application 313 is capable of not only transmitting and receiving Group 3 faxes and Group 4 faxes, but also converting the fax-received data into a protocol such as e-mail and transferring the data by using a transfer function. The fax application 313 is available with not only a conventional telephone line, but also with an Internet fax for transmitting and receiving faxes using the Internet.

The print application 314 is capable of receiving print data transmitted from a host computer in a PDL language such as PostScript or LIPS and printing the print data on paper at a high speed. LIPS represents LBP Image Processing. PDL represents Page Description Language. In the print application 314, it is possible to receive BMLinks, which is a format common to various printers, from the outside and print the BMLinks on paper. Further, the print application 314 can directly receive application data such as PDF data from the outside without using a printer driver and print the data on paper. PDF represents Portable Document Format.

The event receiving unit 307 receives various events from the authentication processing unit 308, the auto-clear processing unit 309, and the print management unit 310. The event receiving unit 307 can also receive various events reported from other modules (not shown).

The authentication processing unit 308 displays an authentication screen on the operation unit 209 or the client PC 102, and performs user authentication using authentication information such as a user ID and a password inputted from the user.

If the user authentication is successful, the authentication processing unit 308 performs a login process for logging the user into the image processing apparatus 100. If a logout instruction is given, the authentication processing unit 308 performs a logout process for logging out the logged-in user from the image processing apparatus. The logout instruction is issued if the logout button displayed on the operation unit 209 is pressed by the user or if the auto-clear processing described later is executed. If the login processing and logout processing are performed, the authentication processing unit 308 transmits an event (login event or logout event) indicating that the processing has been performed to the event receiving unit 307. As will be described later, the authentication processing unit 308 controls the display timing of the authentication screen based on the display setting of the authentication screen.

The auto-clear processing unit 309 performs the auto-clear processing if no operation has been performed on the operation unit 209 for a predetermined time (hereafter referred to as “auto-clear transition time”). The auto-clear processing is a process of clearing setting values/a setting state on the screen displayed in the operation unit according to the fact that no operation has not been performed to the operation unit for a predetermined time and returning the setting values/setting state to the initial values. For example, if the user leaves the image processing apparatus 100 in the middle of setting various parameters about copying through a screen and the auto-clear transition time elapses, the setting values that are already set are cleared and returned to the default setting values. With the auto-clear function, it is possible to prevent the next user from unintentionally taking over the setting state of the previous user and performing the copying or the like with an unexpected setting that has been set by the previous user. It is also possible to prevent the next user from seeing the setting that should not be seen.

The auto-clear processing unit 309 sends an auto-clear event to the event receiving unit 307 if the auto-clear processing occurs. Also, if the auto-clear processing is performed, the authentication processing unit 308 performs the logout processing for logging out the user. Note that the auto-clear transition time can be set by the user from the operation unit 209 or the client PC.

In addition, the user can set a screen to be changed when performing the auto-clear processing from the operation unit 209 or the client PC. If an initial screen is set as a screen to be changed when performing the auto-clear processing, a screen of the operation unit 209 changes from the previous screen to the initial screen by the auto-clear processing. The initial screen indicates a screen preset by the user as a screen to be displayed at the time of starting the device. For example, as an initial screen, a main menu screen for selecting a function to be used from multiple functions and applications of the image processing apparatus 100. An application screen corresponding to each function can be also set as the initial screen. In the following description, the initial screen is set as a screen displayed when performing the auto-clear processing and the main menu screen is set as the initial screen.

The screen control unit 303 switches screens managed for each application and outputs the screen to the operation unit 209.

The print management unit 310 starts a print job. The print management unit 310 notifies the event receiving unit 307 of the start of the print job.

Note that the authentication processing unit 308, the auto-clear processing unit 309, the screen control unit 303, and the print management unit 310 are common processing units and management unit for each application comprised by the application 311, and may be related to each other. Further, these units may be related to other common management units and processing units (not shown).

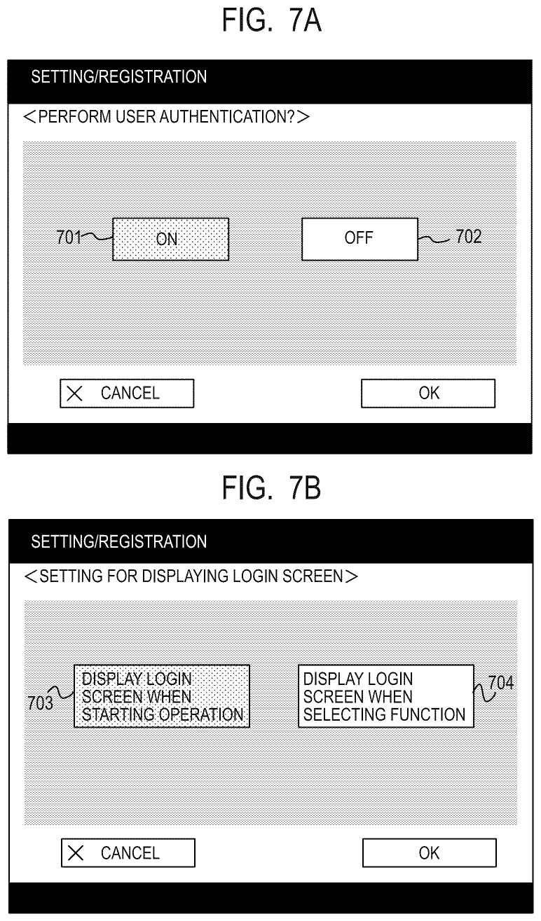

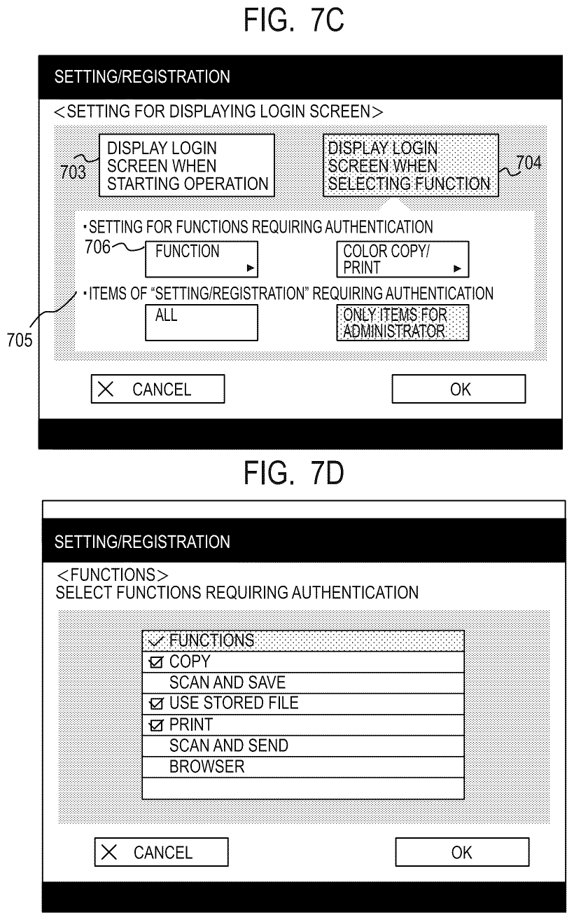

FIGS. 7A to 7D are diagrams showing an example of a screen for setting the user authentication.

The screens shown in FIGS. 7A to 7D are displayed only if a user having the authority as an administrator logs in.

FIG. 7A shows a screen for setting whether to use the user authentication.

The button 701 is used for enabling the user authentication, and if the button 701 is selected, an authentication screen as shown in FIG. 5A is displayed, and the user authentication is required to use each function of the image processing apparatus 100.

The button 702 is used for disabling the user authentication, and if the button 702 is selected, the authentication screen is not displayed, and each function of the image processing apparatus 100 can be used without the user authentication.

One of the buttons 701 and 702 is exclusively selected, so that if one is selected, the other is deselected.

In the screen of FIG. 7A, the OK button is used for applying the setting of the screen of FIG. 7A. If the OK button is pressed, the CPU 201 stores a set value corresponding to the setting of the screen shown in FIG. 7A to the HDD 204. At this time, if the button 701 is selected, the screen moves to the screen shown in FIG. 7B or FIG. 7C. If the button 702 is selected, the screen shown in FIG. 7A is ended. The cancel button is used for canceling the setting on the screen of FIG. 7A. If the cancel button is pressed, the CPU 201 discards the setting on the screen of FIG. 7A and ends the screen of FIG. 7A.

FIGS. 7B and 7C shows screens for switching the display setting of the authentication screen, and the timing of the user authentication is determined according to the setting through the screen.

FIG. 7B shows a screen if the button 703 is selected.

FIG. 7C shows a screen if the button 704 is selected.

One of the buttons 703 and 704 is exclusively selected, so that if one is selected, the other is deselected.

The button 703 is used for displaying the authentication screen when the user starts operating the image processing apparatus 100. If the button 703 is selected, the authentication screen is displayed when the user starts the operation, and then the user authentication is required. In other words, if the authentication screen is set to be displayed at the start of the operation, the user authentication is required first regardless of which function is used.

The button 704 is used for displaying the authentication screen when each function is selected. If the button 704 is selected, a screen 705 for selecting a function requiring the user authentication is popped up as shown in FIG. 7C. If a button 706 is selected, the screen shown in FIG. 7D is displayed.

FIG. 7D shows a screen for selecting a function requiring the user authentication among multiple functions included in the image processing apparatus 100. Functions requiring the user authentication are selected and set via the screen of FIG. 7D, and the authentication screen is displayed when the selected functions are used. On the other hand, functions not selected via the screen of FIG. 7D as requiring the user authentication, the unselected functions can be used without performing the user authentication.

In FIG. 7D, the functions of “copy”, “use stored file”, and “print” are selected as the functions requiring the user authentication. On the other hand, the functions of “scan and save”, “scan and send” and “browser” do not require the user authentication.

Thus, if the button 704 is selected, the authentication screen is not displayed when the user starts operating the operation of the image processing apparatus 100. When the user uses each function, the authentication screen is displayed depending on the selected function, and the user authentication is required.

In the screens of FIGS. 7B to 7D, the OK button is used for applying the settings shown in the screens of FIGS. 7B to 7D. If the OK button is pressed, the CPU 201 stores setting values corresponding to the setting inputted to the screen of FIGS. 7B to 7D in the HDD 204, and ends the screen shown in FIGS. 7B to 7D. The cancel button is used for cancelling the setting in the screens of FIGS. 7B to 7D. If the cancel button is pressed, the CPU 201 discards the setting in the screens of FIGS. 7B to 7D and ends the screens of FIGS. 7B to 7D.

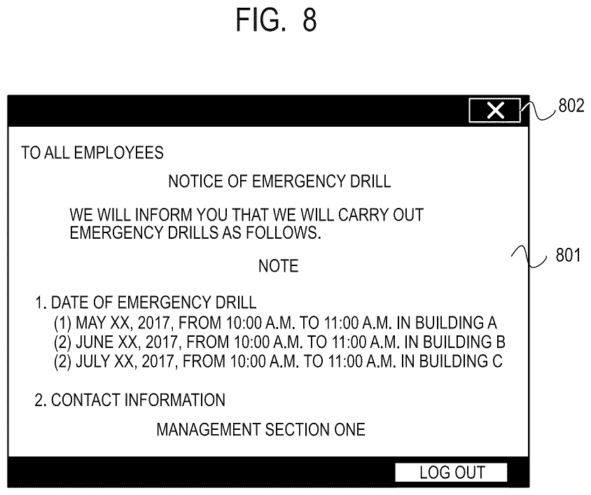

FIG. 8 is a diagram showing an example of a screen if a previously registered Web content is displayed by the signage application 300.

The Web content 801 displays the Web content acquired by the signage application 300 from the content server 120. Here, according to the content setting management table 306 shown in FIG. 6, the HTML file identified by “https://guest_webdav/signage.html” is displayed.

When the user presses a close button 802, the Web content 801 is not displayed.

In the example of FIG. 8, the content related to “notice of emergency drill” is displayed. In this way, notification to employees is registered as Web content and displayed on the image processing apparatus 100 using the signage application 300, which can be used to support information sharing to employees and to control corporate information.

Next, the display timing of the Web content will be described. As described above, the flow of the screen displayed differs depending on the setting for the user authentication via the screens shown in FIGS. 7A to 7D. In the present embodiment, in order to effectively utilize the image processing apparatus 100 as a signage, the Web content is displayed at a proper timing according to the setting related to the user authentication in consideration of the difference in the screen flow.

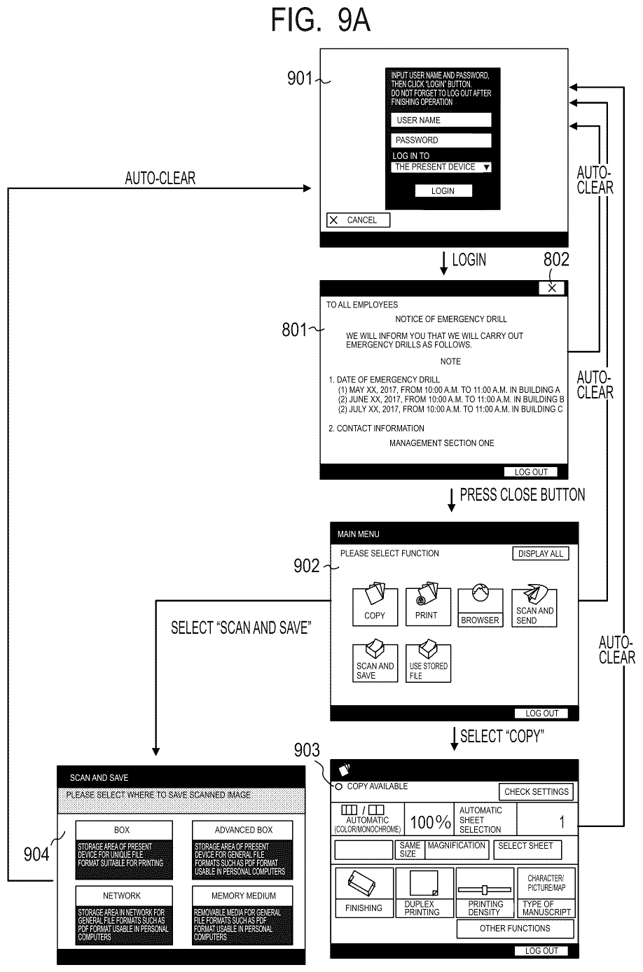

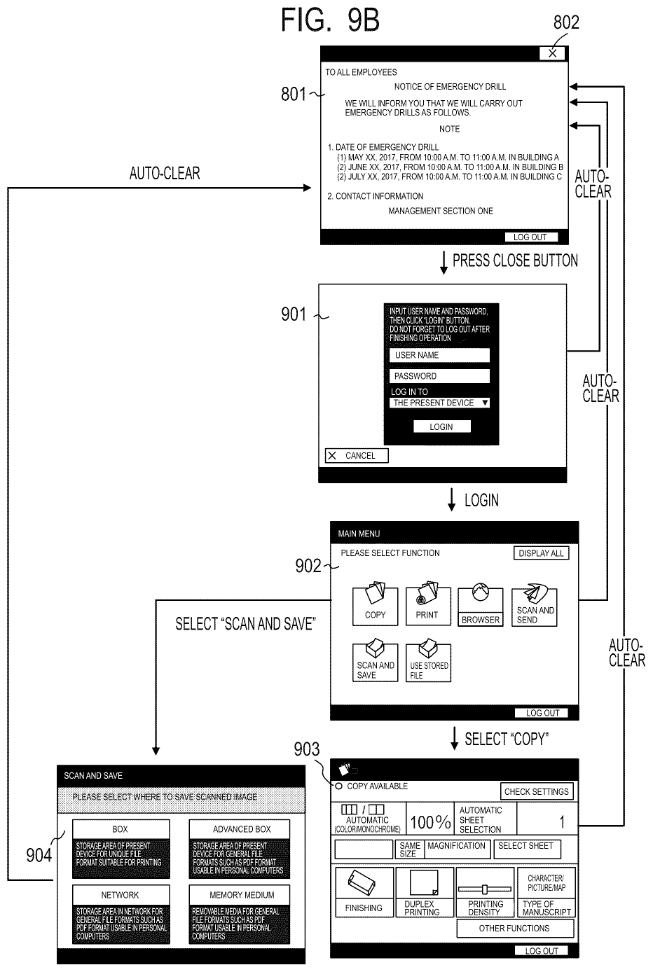

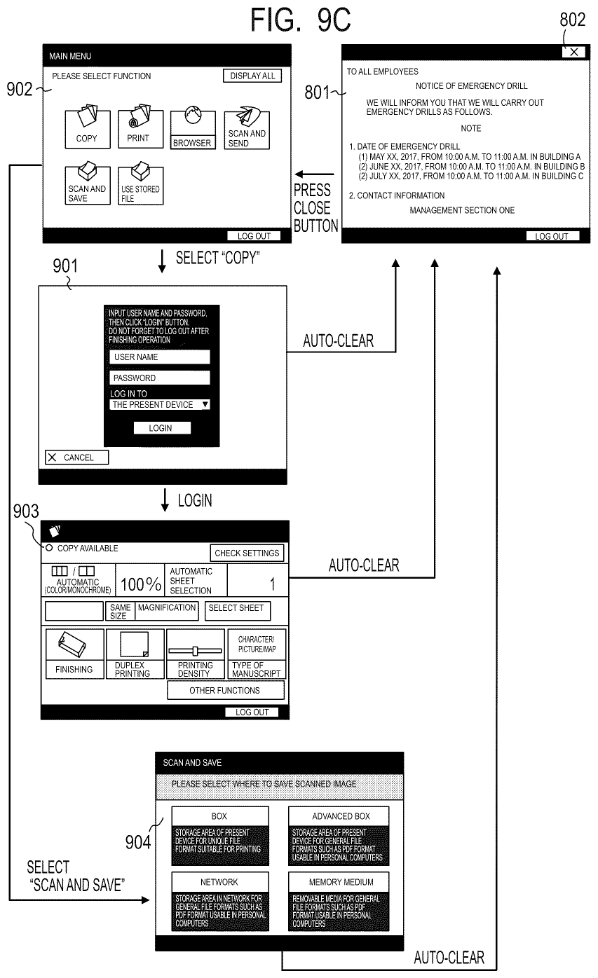

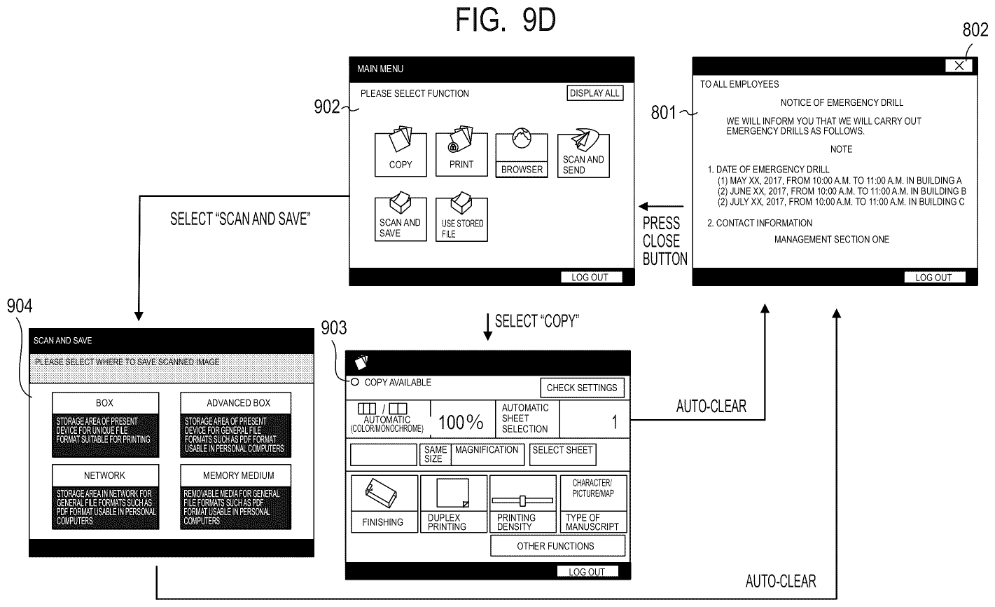

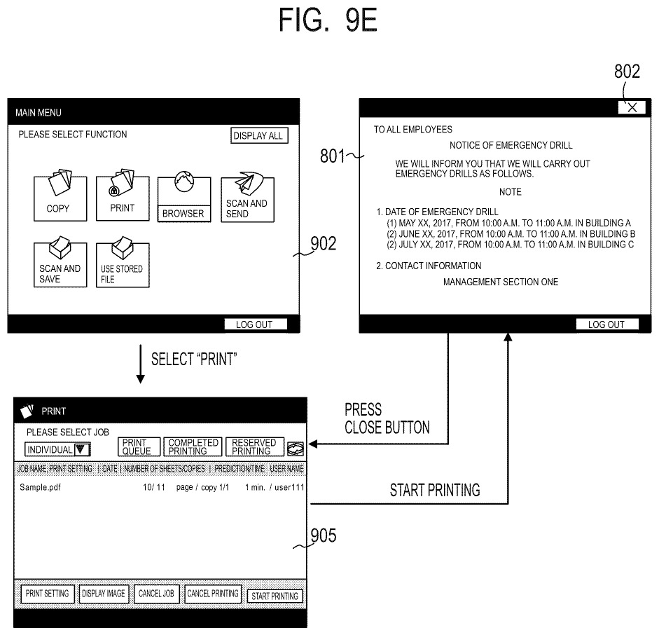

FIGS. 9A to 9E are diagrams showing screen transitions displayed in the operation unit 209 when the display of the signage application 300 is set to ON.

FIGS. 9A, 9B, and 9C show the screen flow if the button 701 is selected on the screen of FIG. 7A, that is, in case that the user authentication function is set to ON. The detail of the flow will be described in detail below.

FIG. 9A shows a screen flow if the button 703 is selected in the screen of FIG. 7B and the check box 513 is selected in the screens of FIG. 5E and FIG. 5F. That is, the screen flow in the case of the setting for displaying the authentication screen at the time of starting the operation and the setting for displaying the content after the login is shown.

In this case, if the user authentication is successful based on the authentication information inputted by the user through the authentication screen 901 and the login processing is completed, the web content display unit 302 displays the screen 801 of the signage application 300 in the operation unit 209. This screen 801 is same as the screen shown in FIG. 8. If the close button 802 is pressed, the screen 801 is not displayed, and the main menu screen 902 is displayed.

Thus, if the setting for displaying the authentication screen at the start of the operation is selected and the setting for displaying the Web content after the login is selected, the Web content is displayed by the signage application 300 at the timing when the login of the user is completed. Therefore, since the Web content is displayed when the user starts using the image processing apparatus 100, the user's attention can be drawn to the Web content, and it is possible to effectively inform the user of the notification from the company.

FIG. 9B shows the screen flow if the button 703 is selected on the screen of FIG. 7B and the check box 503 is selected on the screens of FIG. 5E and FIG. 5F. That is, the screen flow for the case where the authentication screen is set to be displayed when the operation is started and the content is set to be displayed after the logout/auto-clear process is shown. In this example, it is assumed that the check box 513 is not selected in the screens of FIGS. 5E and 5F, that is, the content is not set to be displayed after login.

If the auto-clear transition time elapses without the user operating the operation unit 209 and the auto-clear processing is consequently performed, the web content display unit 302 displays the screen 801 of the signage application 300 in the operation unit 209. If the close button 802 is pressed, the screen 801 is not displayed, and the authentication screen 901 is displayed. The screen 801 is same as the screen shown in FIG. 8. If the user authentication is successful based on the authentication information inputted by the user through the authentication screen 901 and the login processing is completed, the main menu screen 902 is displayed.

In this manner, if the authentication screen is set to be displayed at the start of the operation and the web content is set to be displayed after the end of the operation after the auto-clear process is performed, the web content is displayed by the signage application 300 at the timing when the auto-clear process is performed. Therefore, since the web contents are displayed before the user operates the image processing apparatus 100, the web contents are more likely to be caught in the eye of the user even if the user does not intend to operate the image processing apparatus 100 or just passes the front of the image processing apparatus 100. As a result, the above configuration is expected to work effectively as an advertisement.

FIG. 9C shows a screen flow if the button 704 is selected on the screen of FIG. 7C and the check box 503 is selected on the screens of FIG. 5E and FIG. 5F. That is, the screen flow if the authentication screen is set to be displayed when selecting a function and the content is set to be displayed after the logout/auto-clear process is shown. Here, it is assumed that the “copy”, “use stored file”, and “print” functions are selected as functions requiring authentication, as shown in FIG. 7D.

In this case, the screen of the signage application 300 is not displayed even if the user authentication and the login processing are completed based on the information inputted through the authentication screen 901. Instead, when the auto-clear transition time elapses without the user operating the operation unit 209 and the auto-clear processing is performed, the screen 801 of the signage application 300 is displayed. If the close button 802 is pressed, the screen 801 is not displayed, and the main menu screen 902 is displayed.

Thus, if the setting for displaying the authentication screen at the time of function selection is selected via FIG. 7B, the Web content is not displayed at the time when the user logs in, but the Web content is displayed at the time when the auto-clear process is performed. Here, it is assumed that even if the authentication screen is set to be displayed at the time of selecting a function, the Web content is displayed at the timing of log-in in the same manner as the setting of the authentication screen to be displayed at the time of starting the operation. Then, if the user selects a function requiring the user authentication, the web content is displayed. On the other hand, if a function which does not require the user authentication is selected, the web content is not displayed as the login process is not performed. For example, assume a user who frequently uses the “scan and save” function requiring no user authentication and rarely uses the “copy” function requiring the user authentication. If the setting of displaying web content when performing the auto-clear process is not selected, the user would have little chance to see the web content. Setting the Web content to be displayed at the time when performing the auto-clear process allows the user to see the Web content even if the user initially uses the image processing apparatus 100 after the auto-clear process at the timing of the user first operating the operation unit 209. Therefore, it is possible to use the image processing apparatus 100 as a terminal for advertisement while the image processing apparatus is waiting regardless of the function to be used, and it is possible to effectively inform the user of the notification.

FIG. 9D shows the screen flow if the button 702 is selected on the screen of FIG. 7A and the check box 503 is selected on the screens of FIG. 5E and FIG. 5F. That is, the screen flow if the user authentication function is set to OFF and the content is set to be displayed after the logout/auto-clear process is shown.

In this case, as in the case of FIG. 9C, the screen 801 of the signage application 300 is displayed at the timing when performing the auto-clear process.

Thus, even if the user authentication function is not used, the image processing apparatus 100 can be effectively used as a signage by the setting for displaying Web content at the timing when performing the auto-clear process.

FIG. 9E shows a screen flow if the check box 523 is selected in the screens of FIGS. 5E and 5F. That is, the screen flow for the case where the content is set to be displayed at the start of printing is shown.

If the user selects the “print” function on the main menu screen 902, a print screen 905 is displayed. If the user starts printing in this state and the check box 523 is checked on the screens of FIGS. 5E and 5F, the web content display unit 302 displays the screen 801 of the signage application 300 on the operation unit 209. If the close button 802 is pressed, the screen 801 is not displayed, and the print screen 905 is displayed.

On the other hand, the screen 801 of the signage application 300 is not displayed if the check box 523 is not checked on the screens of FIGS. 5E and 5F when the user starts the printing operation while displaying the print screen 905.

The screen 801 of the signage application 300 is not displayed either when accepting the start of a print job without displaying the print screen 905.

FIG. 10 is a diagram showing an example of an error screen 1001 displayed in the operation unit 209 if an error is detected at the timing of displaying Web content by the signage application 300.

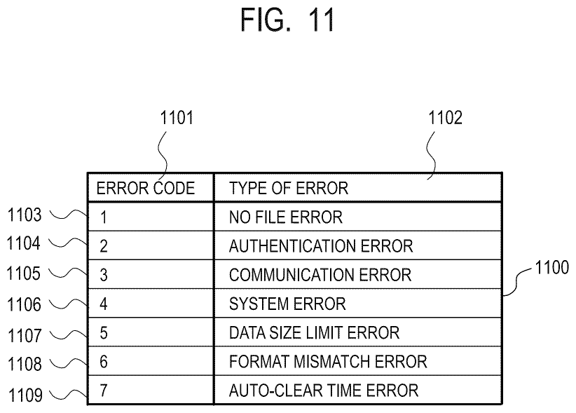

The contents of the detected error are displayed in an error message display area 1002 of the error screen 1001. In the example of FIG. 10, an error is displayed to notify “communication error” if a communication error is detected. The type of error displayed on the error screen by the signage application 300 is not limited to this, and for example, an error message corresponding to multiple types of errors as described with reference to FIG. 11 is displayed in the error message display area 1002.

FIG. 11 is a diagram showing an example of an error management table 1100 for managing errors that occur when Web content is displayed. The error management table 1100 may be stored in the HDD 204 of the image processing apparatus 100 or in the content server 120.

The reference numeral 1101 denotes an error code for determining the detected error. The reference numeral 1102 denotes an error type corresponding to the error code.

The reference numeral 1103 denotes a “no-file error” which occurs when attempting to acquire Web content according to the file path entered in the text boxes 505 of FIGS. 5E and 5F but fails the acquisition due to the absence of the Web content, for example.

The reference numeral 1104 denotes an “authentication error” that occurs if authentication is required for the file path inputted in the text box 505, and the authentication is performed in accordance with the inputs to the text boxes 506, 507 but is rejected.

The reference numeral 1105 corresponds to a “communication error” which occurs when attempting to acquire the Web content from the content server 120 but the acquisition is unsuccessful due to a network failure or the like.

The reference numeral 1106 denotes an error other than 1103 to 1105 or 1107 to 1109, and corresponds to a “system error” that occurs due to a failure of the image processing apparatus 100 or the like that the signage application 300 does not expect.

The reference numeral 1107 corresponds to a “data size limit error” which occurs if it is found that the Web contents exceeds the predetermined upper limit of acceptable data size when acquiring the Web content.

The reference numeral 1108 denotes a “format mismatch error” that occurs if the acquired Web content is not in a format displayable by the web content display unit 302.

The reference numeral 1109 denotes an “auto-clear time error” that occurs if auto-clear transition time (not shown) is set to less than a predetermined time, so that the web content cannot be displayed when the auto-clear event is detected.

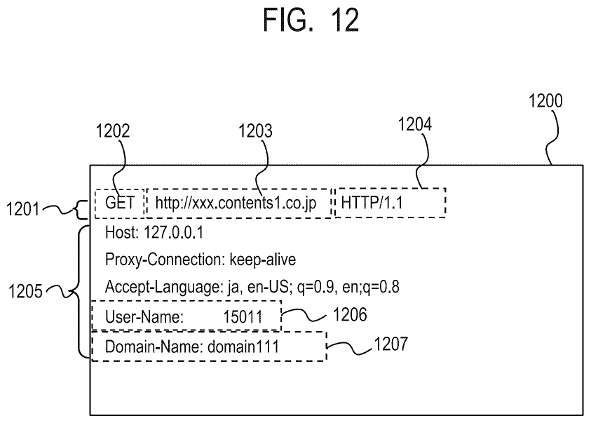

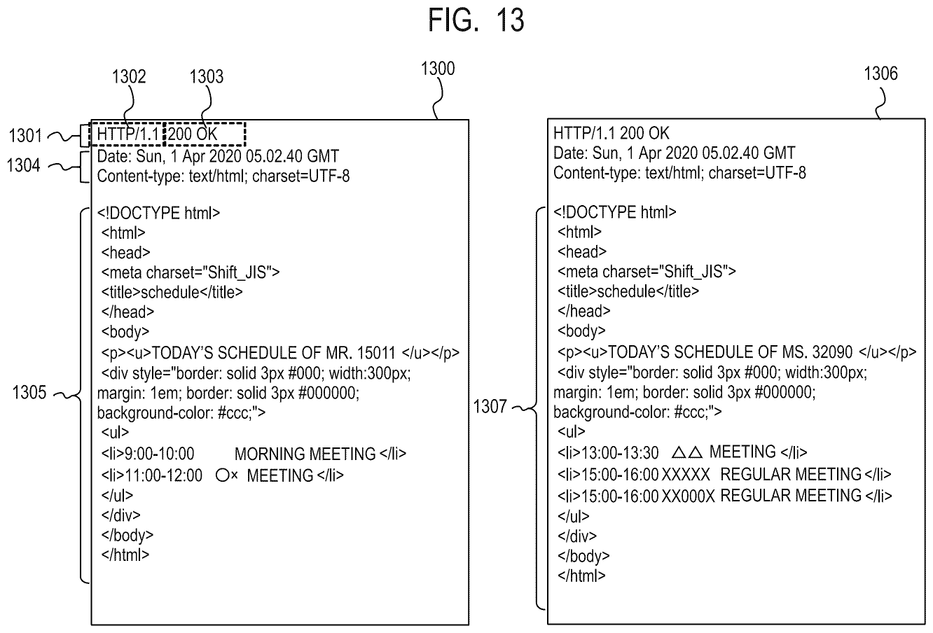

FIG. 12 is a diagram for describing a HTTP request 1200 reported from the image processing apparatus 100 to the content server 120 if the content type displayed by the signage application 300 is set to HTML and a signage display trigger is generated.

In the HTTP request 1200, a request line 1201 includes a method 1202, a request target 1203, and an HTTP version 1204. One of the content paths 608, 618 and 628 is set in the request target 1203.

A header 1205 describes detailed information of the request, and the contents can be changed according to the request. In this embodiment, a user name 1206 and a domain name 1207 are added.

The user name 1206 is a domain name obtained if the authentication by the authentication processing unit 308 of the image processing apparatus 100 is successful.

The domain name 1207 is a domain name obtained upon the successful authentication by the authentication processing unit 308 of the image processing apparatus 100.

The user name 1206 and domain name 1207 enable the content server 120 to acquire user attributes from the image processing apparatus 100.

When receiving the HTTP request 1200 from the image processing apparatus 100, the content server 120 analyzes the content of the request and registers the analysis result in the content management table 1500 shown in FIG. 15.

FIG. 15 is a diagram showing an example of a content management table 1500 for managing information acquired by the content server 120 from the HTTP request received from the image processing apparatus 100. The content management table 1500 is stored in a storage device such as an HDD of the content server 120.

In the content management table 1500, when the request is received is registered in a date and time 1501. The request target 1203 of the HTTP request 1200 is registered in a content path 1502. The user name 1206 of the HTTP request 1200 is registered in a user name 1503. The domain name 1207 of the HTTP request 1200 is registered in a domain name 1504. If the information about the user name 1206 and the domain name 1207 of the HTTP request 1200 is not provided, nothing is registered in the user name 1503 and the domain name 1504 of the content management table 1500, as shown in No 3 of FIG. 15.

FIG. 13 is a diagram showing an example of an HTTP response 1300 that is transmitted from the content server 120 to the image processing apparatus 100 in response to the HTTP request 1200 as shown in FIG. 12.

In the HTTP response 1300, the status line 1301 includes an HTTP version 1302 and a status 1303.

A header 1304 shows detailed information of the response and can be modified.

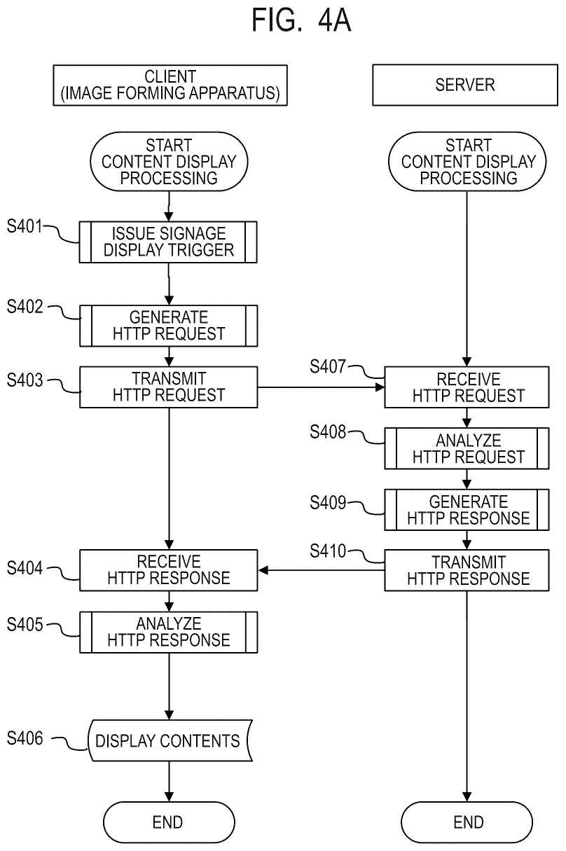

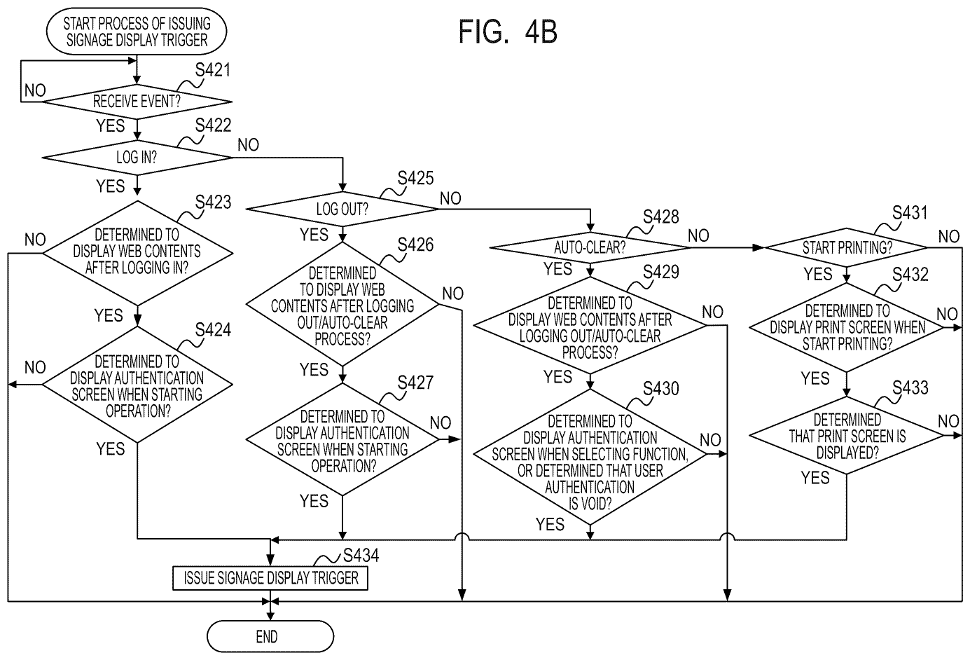

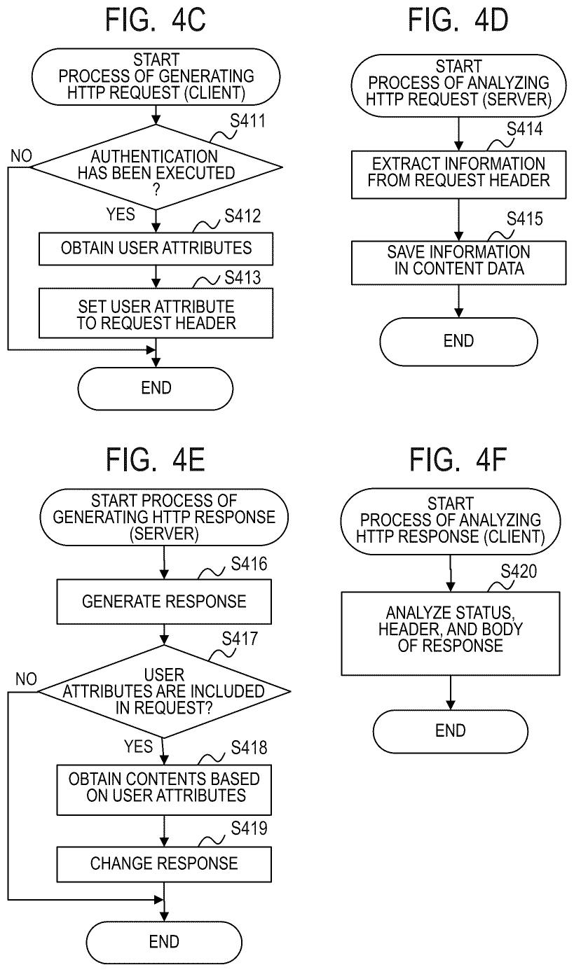

A body 1305 indicates information such as HTML or an image. In the present embodiment, the content server 120 refers to the content management table 1500, acquires the domain name 1504 of the relevant data, and changes the body 1305 of the HTTP response 1300 according to the user attribute. For example, the content of the body 1305 in the HTTP response 1300 and a body 1307 in an HTTP response 1306 are changed according to the user attribute. Specifically, the body 1305 in the HTTP response 1300 contains “Today's schedule of Mr. 15011” and the body 1307 in the HTTP response 1306 contains “Today's schedule of Ms. 32090”. The details about changing the contents of the body according to the user attribute will be described with reference to FIGS. 4A to 4F later.

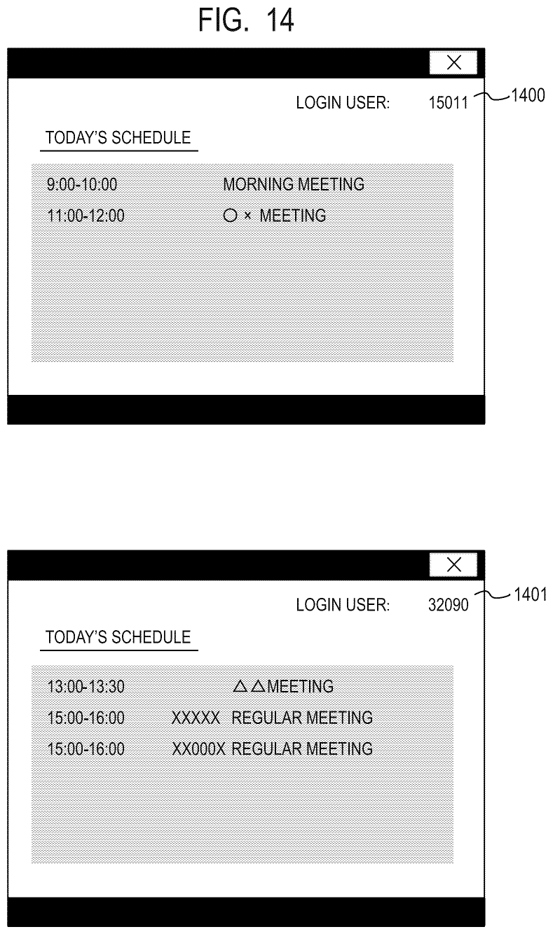

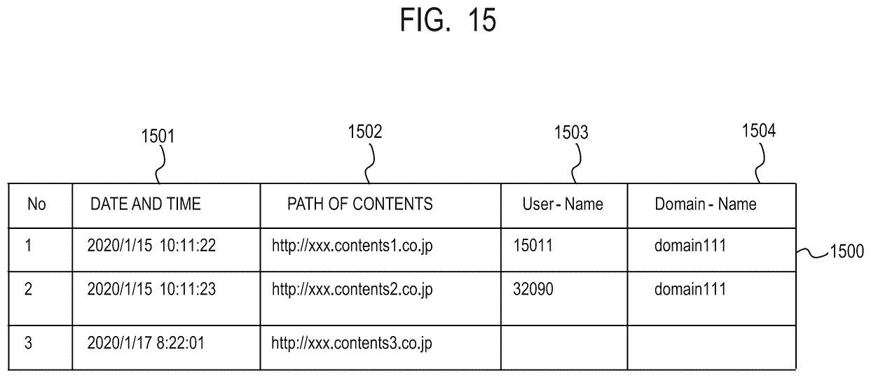

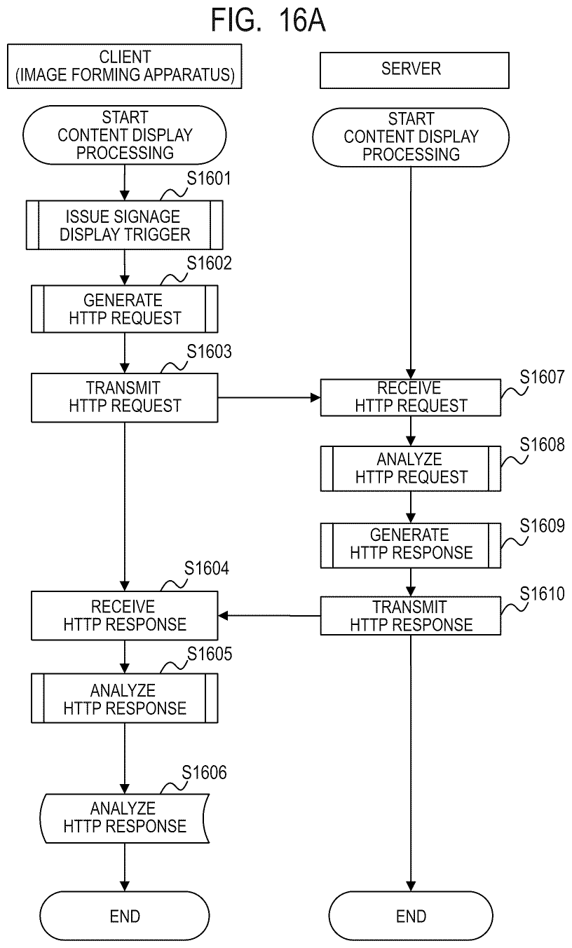

FIG. 14 is a diagram showing an example of different screens of the signage application 300 displaying different contents depending on the user's attributes.

A content screen 1400 is displayed when the image processing apparatus 100 receives the HTTP response 1300, and the content screen 1400 shows the content of the body 1305 in the HTTP response 1300.

A content screen 1401 is displayed if the image processing apparatus 100 receives the HTTP response 1306, and displays the contents of the body 1307 in the HTTP response 1306.

In the image processing apparatus 100, the signage application 300 can display different contents for each user by receiving a response changed by the content server 120 according to the user attributes.

FIGS. 4A to 4F are flowcharts showing an example of a process in which the image processing apparatus 100 receives contents from the content server 120 according to user attributes and the signage application 300 displays the contents according to the first embodiment. In each flow chart of each figure, the processing of the image processing apparatus 100 is implemented by the CPU 201 in the image processing apparatus 100 that reads and executes the control program stored in the ROM 202 or the HDD 204. The processing of the content server 120 is implemented by a CPU of a computer (not shown) constituting the content server 120 that reads and executes a control program stored in a storage device such as an HDD.

FIG. 4A shows the overall process for providing and receiving contents according to user attributes between the image processing apparatus 100 and the content server 120, and for displaying the contents through the signage application 300.

In step S401, the CPU 201 of the image processing apparatus 100 issues a trigger for displaying Web content. The process of step 401 will be described in detail with reference to the flowchart of FIG. 4B.

FIG. 4B shows a process for receiving an event of displaying the Web content and for determining to issue the trigger for displaying the Web content according to the parameters set in items 503 to 532 shown in FIGS. 5E and 5F.

In step S421, the CPU 201 determines whether the event receiving unit 307 has received a login event or a logout event from the authentication processing unit 308, or an auto-clear event from the auto-clear processing unit 309, or a print start event from the print management unit 310. If none of the events has been received (NO in S421), the CPU 201 returns the process to step S421, and continues monitoring the reception of the event.

If either event is received (Yes in S421), the CPU 201 advances the processing to step S422.

In step S422, the CPU 201 determines whether the event received in step S421 is the login event. If it is the login event (Yes in S422), the CPU 201 advances the process to step S423.

In step S423, the CPU 201 uses the content management unit 305 to acquire a setting parameter corresponding to the key 613 from the content setting management table 306, and determines whether or not the setting for displaying the Web content after login is activated (i.e., “ON”). If the setting for displaying the Web content after the login is not activated (NO in step S423), the CPU 201 ends the process of FIG. 4B.

If the setting for displaying the Web content after login is activated (Yes in step S423), the CPU 201 advances the process to step S424.

In step S424, the CPU 201 determines through the authentication processing unit 308 whether or not the authentication screen is set to be displayed at the time of starting the operation. If the authentication screen is not set to be displayed at the time of starting the operation (No in step S424), that is, if the authentication screen is set to be displayed at the time of selecting a function, the CPU 201 ends the processing of FIG. 4B.

On the other hand, if the authentication screen is set to be displayed at the time of starting the operation (Yes in step S424), the CPU 201 advances the process to step S434. The process after step S434 will be described later.

If the CPU 201 determines in step S422 that the event received in step S421 is not the login event (NO in step 422), the process proceeds to step S425.

In step S425, the CPU 201 determines whether the event received in step S421 is the logout event. If the event received in step S421 is the logout event (Yes in step S425), the CPU 201 advances the process to step S426.

In step S426, the CPU 201 obtains a setting parameter corresponding to the key 603 from the content setting management table 306 through the content management unit 305, and determines whether or not the setting for displaying the Web content at the time of the logout/auto-clear process is activated. If the setting for displaying the Web content at the time of the logout/auto-clear process is not activated (NO in step S426), the CPU 201 ends the processing of FIG. 4B.

If the setting for displaying the Web content at the time of the logout/auto-clear process is activated (Yes in step S426), the CPU 201 advances the process to step S427.

In step S427, the CPU 201 determines through the authentication processing unit 308 whether or not the authentication screen is set to be displayed at the time of starting the operation. If the authentication screen is not set to be displayed at the time of starting the operation (No in step S427), that is, if the authentication screen is set to be displayed at the time of selecting a function, the CPU 201 ends the processing of FIG. 4B.

On the other hand, if the authentication screen is set to be displayed at the time of starting the operation (Yes in step S427), the CPU 201 advances the process to step S434.

If the CPU 201 determines in step S425 that the event received in step 421 is not the logout event (NO in step S425), the process proceeds to step S428.

In step S428, the CPU 201 determines whether the event received in step S421 is the auto-clear event. If the event is the auto-clear event (Yes in step S428), the CPU 201 advances the process to step S429.

In step S429, the CPU 201 obtains a setting parameter corresponding to the key 603 from the content setting management table 306 through the content management unit 305, and determines whether or not the setting for displaying the Web content at the time of the logout/auto-clear process is activated. If the setting for displaying the Web content at the time of the logout/auto-clear process is not activated (NO in step S429), the CPU 201 ends the process of FIG. 4B.

If the setting for displaying the Web content at the time of the logout/auto-clear process is activated (Yes in step S429), the CPU 201 advances the process to step S430.

In step S430, the CPU 201 determines through the authentication processing unit 308 whether the authentication screen is set to be displayed at the time of selecting a function or the user authentication is set to be invalid. If the authentication screen is not set to be displayed at the time of selecting function or the user authentication is not set to be invalid, that is, the authentication screen is set to be displayed at the time of starting the operation (No in step S430), the CPU 201 ends the processing of FIG. 4B. Although not shown in FIG. 4B, even in case of “No” in step S430, the process exceptionally proceeds to step S434 if the check box 513 is not selected in the screens of FIGS. 5E and 5F, that is, in case that the content is not set to be displayed after the login.

On the other hand, if the authentication screen is set to be displayed at the time of selecting a function or the user authentication is set to be invalid (Yes in step S430), the CPU 201 advances the process to step S434.

If the CPU 201 determines in step S428 that the event received in step S421 is not the auto-clear event (NO in step S428), the CPU 201 advances the process to step S431.

In step S431, the CPU 201 determines whether the event received in step S421 is the print start event. If the event received in step S421 is not the print start event (No in step S431), the CPU 201 ends the process of FIG. 4B.

If the event received in step S421 is the print start event (Yes in step S431), the CPU 201 advances the process to step S432.

In step S432, the CPU 201 uses the content management unit 305 to obtain a setting parameter corresponding to the key 623 from the content setting management table 306, and determines whether the display at the start of printing is activated. If the display at the start of printing is deactivated (NO in step S432), the CPU 201 ends the process of FIG. 4B.

If the display at the start of printing is activated (YES in step S432), the CPU 201 advances the process to step S433.

In step S433, the CPU 201 determines through the screen control unit 303 whether the print screen 905 is displayed in the operation unit 209. If the print screen 905 is not displayed (NO in step S433), the CPU 201 ends the process of FIG. 4B.

If the print screen 905 is displayed (Yes in step S433), the CPU 201 advances the process to step S434.

In step S434, the CPU 201 issues a trigger for displaying a signage and ends the process of FIG. 4B.

When the processing of FIG. 4B is completed, the CPU 201 advances the process to step S402 of FIG. 4A.

In step S402, if the content setting management table 306 shows that the setting parameters of the keys 604, 614, 624 indicate HTTP/WebDAV and HTML is set to the keys 608, 618, 628, the CPU 201 generates a request. Generating an HTTP request is described in detail in FIG. 4C.

In FIG. 4C, as a first step (not shown), the CPU 201 generates the information (information other than the user name 1206 and the domain name 1207) of the HTTP request 1200 as shown in FIG. 12, and advances the process to step S411. In the request target 1203, the content path 618 is set if the generation of the trigger for displaying signage is caused by the login process, the content path 608 is set if the generation is caused by the logout or auto-clear process, and the content path 628 is set if the generation is caused by the print start process. The information (information other than the user name 1206 and the domain name 1207) of the HTTP request 1200 may be prepared in advance, and in this case, the content path corresponding to the event generating the trigger for displaying signage is set in the request target 1203.

In step S411, the CPU 201 determines whether the image processing apparatus 100 has been authenticated by the authentication processing unit 308. If the authentication has not been performed (NO in step S411), the CPU 201 ends the process of FIG. 4C.

If the authentication has been performed (Yes in step S411), the CPU 201 advances the process to step S412.

In step S412, the CPU 201 acquires, from the authentication processing unit 308, a user name and a domain name of the user who has passed the authentication as the user attributes.

Next, in step S413, the CPU 201 assigns (sets) the user attributes acquired in step S412 to the user name 1206 and domain name 1207 of the HTTP request 1200, and ends the process of FIG. 4C.

If the processing of FIG. 4C is completed, the CPU 201 advances the process to step S403 of FIG. 4A.

In step S403, the CPU 201 of the image processing apparatus 100 transmits the HTTP request 1200 generated in step S402 to the content server 120.

If the content server 120 receives the HTTP request 1200 transmitted from the image processing apparatus 100 (step S407), The process proceeds to step S408.

In step S408, the content server 120 analyzes the HTTP request 1200 received in step S407. The process of analyzing the HTTP request is described in detail in FIG. 4D.

In step S414 of FIG. 4D, the content server 120 acquires the user name 1206 and domain name 1207 from the header 1205 of the HTTP request 1200 and acquires the content path (request target 1203) from the request target 1203.

Next, in step S415, the content server 120 stores the user attributes and the content path acquired in step S414 in the content management table 1500, and ends the processing of FIG. 4D.

If the processing of FIG. 4D is completed, the content server 120 advances the process to step S409 of FIG. 4A.

In step S409, the content server 120 generates an HTTP response such as the HTTP response 1300 or 1306 shown in FIG. 13. The generation of the HTTP response is described in detail in FIG. 4E.

In step S416, the content server 120 acquires the content corresponding to the content path 1502 of the content management table 1500 in which the information is stored in step S408, and generates an HTTP response such as the HTTP response 1300 or 1306 shown in FIG. 13 by using the acquired content. Here, it is assumed that contents corresponding to the user attributes are not included yet at this time.

Next, in step S417, the content server 120 determines whether the user attributes are stored in the user name 1503 and the domain name 1504 of the content management table 1500 in which the information is stored in step S408. If the user attributes are not stored in the user name 1503 or the domain name 1504 of the content management table 1500 (No in step S417), the content server 120 ends the processing of FIG. 4E.

If the user attributes are stored in the user name 1503 and the domain name 1504 of the content management table 1500 (Yes in step S417), the content server 120 advances the process to step S418.

In step S418, the content server 120 acquires content suitable for the user according to the user attributes. In the example of FIG. 13, the schedule data corresponding to the user attributes is previously registered in the content server 120, and in step S418, the schedule data corresponding to the user attributes is acquired from the pre-registered information. It is possible to preset where to acquire the content corresponding to the user attributes in the content server 120, and acquire the content corresponding to the user attributes from the preset location. For example, it is possible to register in advance a table associating the user attributes with contents (paths) corresponding to the user attributes in the content server 120, and the entity of the content corresponding to the user attributes shown in the table may be stored in another server (for example, in a database server).

Next, in step S419, the content server 120 reflects the content acquired in step S418 to the body (body 1305, 1307 in the example of FIG. 13) of the HTTP response, changes the HTTP response, and ends the processing of FIG. 4E.

If the processing of FIG. 4E is completed, the content server 120 advances the process to step S410 of FIG. 4A.

In step 410, the content server 120 transmits an HTTP response such as the HTTP response 1300, 1306 of FIG. 13 generated in step S419 to the image processing apparatus 100.

If the CPU 201 of the image processing apparatus 100 receives the HTTP response from the content server 120 (step S404), the CPU 201 advances the process to step S405.

In step S405, the CPU 201 analyzes the HTTP response received in step S404 by using the signage application 300. The analysis of the HTTP response will be described in detail with reference to FIG. 4F.

In step S420 of FIG. 4F, the CPU 201 analyzes the status of the HTTP response (the status line 1301 in the example of FIG. 13), the contents of the header (the header 1304 in the example of FIG. 13), and the contents of the body (the body 1305, 1307 in the example of FIG. 13) to confirm the contents to be displayed. After step S420, the CPU 201 terminates the process of FIG. 4.

If the processing of FIG. 4F is completed, the CPU 201 advances the process to step S406 of FIG. 4A.

In step S406, the CPU 201 causes the signage application 300 to display the content corresponding to the HTTP response in the operation unit 209, and ends the process of this flowchart.

Next, a specific example will be described based on the flowcharts of FIGS. 4A to 4F.

As a specific example 1 and a specific example 2, the process of displaying the content in the case where the signage application 300 is set to display the content at the time of login will be described.

The specific example 1 is a case in which a user with a user name “15011” and a domain name “domain 111” performs a login operation to the image processing apparatus 100 with the check box 513 selected and HTTP/WebDAV selected through the radio button 514.

The user having the user name “15011” and the domain name “domain 111” performs the login operation through the image processing apparatus 100. If the authentication is successful through the authentication processing unit 308 of the image processing apparatus 100, the signage application 300 adds the username 1206 “15011” and domain name 1207 “domain 111” to the HTTP request 1200, and sends the HTTP request 1200 to the content server 120.

The content server 120 analyzes the received HTTP request, acquires the user attributes, i.e., the user name “15011” and the domain name “domain 111” from the HTTP request, and stores them in the row “No. 1” of the content management table 1500.

The content server 120 acquires the user name 1503, the domain name 1504 and the content path 1502 of the row “No. 1” by referring to the information of the stored content management table 1500. Further, the content server 120 acquires contents corresponding to the user attributes of the user name 1503 “15011” and the domain name 1504 “domain 111”. The content server 120 reflects the acquired content on the body 1305 of the HTTP response 1300. The body 1305 includes, for an example, content relating to “today's schedule of the user name 15011”.

Further, the content server 120 transmits the generated HTTP response to the image processing apparatus 100.

The signage application 300 of image processing apparatus 100 analyzes the HTTP response received from the content server 120 and displays the content screen 1400 in the operation unit 209.

The specific example 2 is a case in which a user with a user name “32090” and a domain name “domain 111” logs in using the image processing apparatus 100 with the check box 513 of FIGS. 5E and 5F checked and the HTTP/WebDAV selected through the radio button 514.

The user with the user name “32090” and the domain name “domain 111” performs the login operation using the image processing apparatus 100. If the authentication is successful through the authentication processing unit 308 of the image processing apparatus 100, the signage application 300 adds the username 1206 “32090” and the domain name 1207 “domain 111” to the HTTP request 1200 and sends the HTTP request 1200 to the content server 120.

The content server 120 analyzes the received HTTP request, acquires the user attributes, i.e., the user name “32090” and the domain name “domain 111” from the HTTP request, and stores them in the row “No. 2” of the content management table 1500.

The content server 120 refers to the information of the stored content management table 1500 and acquires the user name 1503 and domain name 1504 of the row “No. 2”. Further, the content server 120 acquires contents corresponding to the user attributes of the user names 1503 “32090” and the domain name “domain 111”. The content server 120 reflects the acquired content on the body 1307 of the HTTP response 1306. The body 1307 includes, for an example, content relating to “today's schedule of the user name 32090”.

Further, the content server 120 transmits the generated HTTP response to the image processing apparatus 100.

The signage application 300 of image processing apparatus 100 analyzes the HTTP response received from the content server 120 and displays the content screen 1401 in the operation unit 209.

In the specific examples 1 and 2 described above, if the HTML content is displayed by the signage application 300 at the time of login, the content can be changed according to the user.

Next, in a specific example 3, the process of displaying the content if the signage application 300 is set to display the content at the time of logout will be described.

In the present example, a user with a user name “15011” and a domain name “domain 111” performs the logout operation using the image processing apparatus 100 with the check box 503 of FIGS. 5E and 5F checked and the HTTP/WebDAV selected through the radio button 504. In this case, the authentication processing unit 308 of the image processing apparatus 100 fails in acquiring the user attributes. Therefore, the signage application 300 transmits the HTTP request 1200 to the content server 120 without adding the user attributes to the user name 1206 and domain name 1207.

The content server 120 analyzes the received HTTP request and stores the attributes except the user name and the domain name of the HTTP request in the row “No. 3” of the content management table 1500.

The content server 120 refers to the stored information of the management table 1500 and acquires the user name 1503 and the domain name 1504 of the row “No. 3”. In this case, since information corresponding to the user attributes (i.e., the username 1503 and the domain name 1504) is empty, the content server 120 does not change the header of the HTTP response.

Then, the content server 120 transmits the generated HTTP response to the image processing apparatus 100.

The signage application 300 of the image processing apparatus 100 analyzes the HTTP response received from the content server 120 and displays the content screen in the operation unit 209.

If there is no change in the HTTP response, the content screen set by the content path 608 in the content setting management table 306 is displayed in the operation unit 209.

In the specific example 3, the content preset in the content setting management table by a content administrator is displayed if the user attributes cannot be obtained through the authentication depending on the timing of the signage application 300 displaying the content.

As described above, according to the first embodiment, if the user operating the image processing apparatus 100 is identified and when requesting the content from the image processing apparatus 100 to the content server 120, information of the user is added to the request, and the content customized by the content server 120 depending on the information of the user is received from the content server 120 and then displayed. Thus, the contents can be properly modified and displayed according to the user attributes and the timing of the signage application 300 displaying the contents.

### Second Embodiment

In the second embodiment, it is described how the signage application 300 displays the content if the check box 537 of FIG. 5G is checked and the notification of the user information is set to be restricted from the image processing apparatus 100 to the content server 120.

The content screen 1401 shown in FIG. 14 of the first embodiment is a screen displayed if the image processing apparatus 100 receives the HTTP response 1306, and the screen shows the contents of the body 1305 of the HTTP response 1300. As described in the first embodiment, the signage application 300 of the image processing apparatus 100 transmits a request including user attributes to the content server 120 and receives a response changed in accordance with the user attributes from the content server 120. Thus, different contents can be displayed for each user. If the check box 537 in FIG. 5G is checked, the signage application 300 of the image processing apparatus 100 sends a request that does not include user attributes to the content server 120. In this case, the signage application 300 receives a response to which the user attributes are not applied from the content server 120, and displays contents that are independent of users. In the second embodiment, this process will be described.

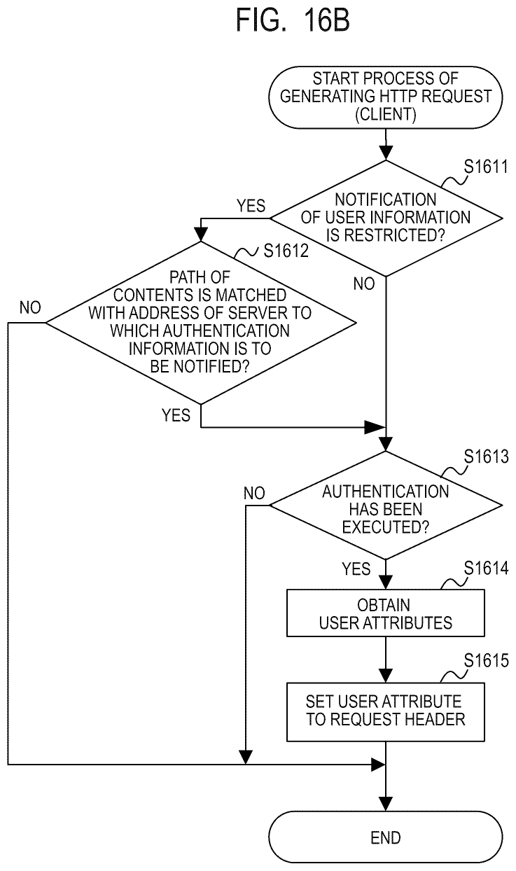

FIGS. 16A and 16B are flowcharts according to the second embodiment showing an example of a process in which the image processing apparatus 100 receives contents from the content server 120 and the signage application 300 displays contents. In the flow charts of FIGS. 16A and 16B, the processing of the image processing apparatus 100 is implemented by the CPU 201 of the image processing apparatus 100 reading and executing a control program stored in the ROM 202 or the HDD 204. The processing of the content server 120 is implemented by a CPU of a computer (not shown) constituting the content server 120 that reads and executes a control program stored in a storage device such as an HDD.

FIG. 16A shows the overall process between the image processing apparatus 100 and the content server 120 for providing contents and the process of the signage application to display contents.

In step S1601, the CPU 201 of the image processing apparatus 100 issues a trigger for displaying Web content. Since the process in step S1601 is same as that shown in FIG. 4B of the first embodiment, description thereof will be omitted.

Next, in step S402, the CPU 201 generates a request if the parameters of the keys 604, 614 and 624 are set to HTTP/WebDAV and HTML is set to the keys 608, 618 and 628 in the content setting management table 306. The generation of an HTTP request will be described in detail with reference to FIG. 16B.

In FIG. 16B, in the first step (not shown), the CPU 201 generates information of the HTTP request 1200 as shown in FIG. 12 (information other than the user name 1206 and the domain name 1207), and advances the process to step S1611.

In step S1611, the CPU 201 determines whether the notification of the user information is set to be restricted in the key 634 of the content setting management table 306. If the notification of the user information is set to be restricted (Yes in step S1611), the CPU 201 advances the process to step S1612.

In step S1612, the CPU 201 determines whether or not a server address stored in the key 635 of the content setting management table 306 for permitting the notification matches the set content path. The set content path here could be the content path 618 if the generation of the signage display trigger is caused by login, the content path 608 if the generation is caused by the logout or the auto-clear process, and the content path 628 if the generation is caused by the print start process. If the server address and the content path do not match (NO in step S1612), the CPU 201 terminates the process of FIG. 16B.

If the notification of the user information is not set to be restricted (NO in step S1611), the CPU 201 advances the process to step 1613.

Note that steps S1613 to S1615 are same as steps S411 to S413 shown in FIG. 4C describing the first embodiment, and therefore description thereof will be omitted.

If the processing of FIG. 16B is completed, the CPU 201 advances the process to step S1603 of FIG. 16A.

The processing in steps S1603 to S1610 is same as steps S403 to S410 shown in FIG. 4A describing the first embodiment, and therefore description thereof will be omitted.

As described above, in the second embodiment, it is possible to further enhance the security by restricting servers providing user information.

### Third Embodiment

In the third embodiment, the content server 120 is operable to determine a state of the requested content and to provide a result of the determination, and the signage application 300 does not display again the content once already displayed.

In the third embodiment, the content server 120 refers to the content management table 1500. If data including the content path 1502, the user name 1503, and domain name 1504 all matched has been already registered, the content server gives a display flag to a response and transmits the response to the image processing apparatus 100. The display flag is information indicating that the content has been viewed through the image processing apparatus 100. The image processing apparatus 100 refers to the display flag of the received response and does not display again the content in the signage application 300 if it is determined that the content has been already viewed.

This process will be described below.

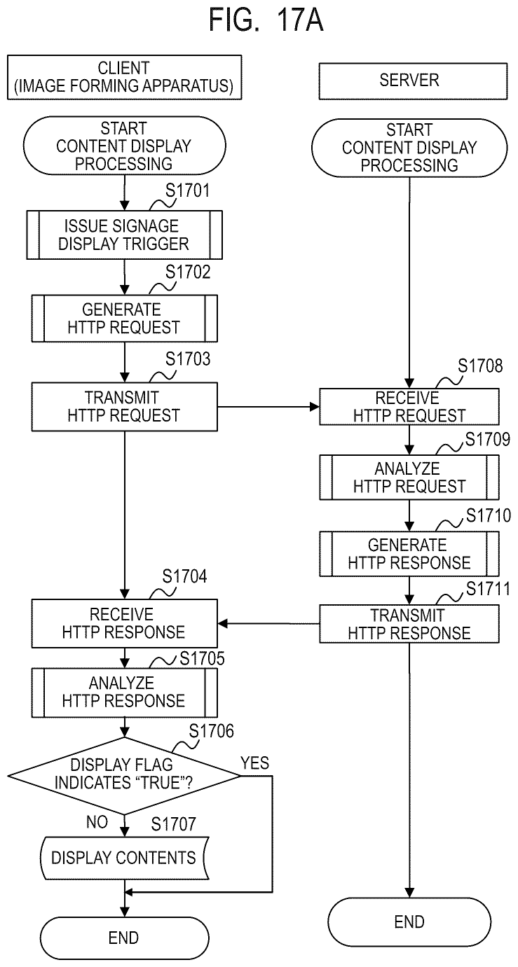

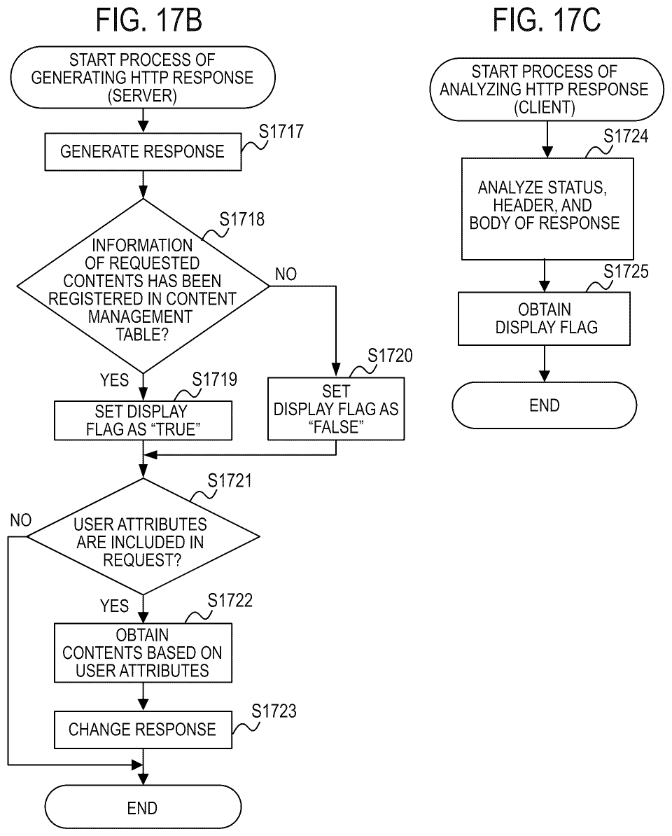

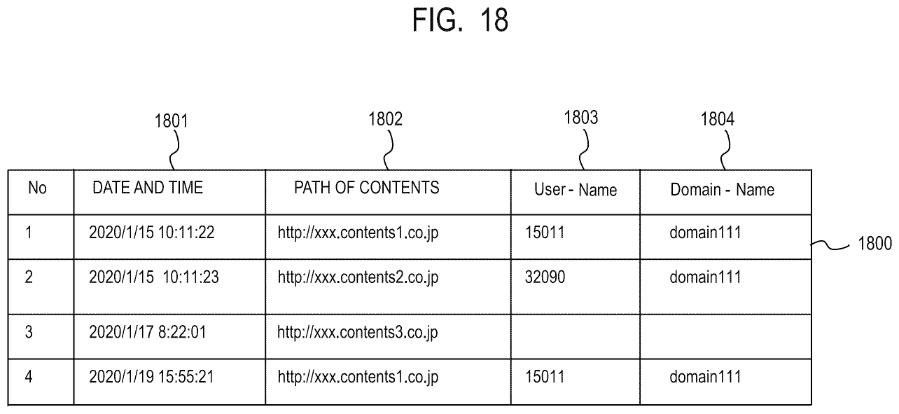

FIGS. 17A to 17C are flowcharts of the third embodiment showing an example of a process in which the image processing apparatus 100 receives contents from the content server 120 and the signage application 300 performs control of displaying the contents. In the flow charts of the FIGS. 17A to 17C, the processing of the image processing apparatus 100 is implemented by the CPU 201 of the image processing apparatus 100 reading and executing a control program stored in the ROM 202 or the HDD 204. The processing of the content server 120 is implemented by a CPU of a computer (not shown) constituting the content server 120 that reads and executes a control program stored in a storage device such as an HDD.

FIG. 17A shows the overall process between the image processing apparatus 100 and the content server 120 for providing contents and for performing control of displaying contents by the signage application 300.

Since the process in steps S1701 to S1703, S1708, and S1709 are same as steps 401 to 403, step S407, and S408 shown in FIG. 4A describing the first embodiment, the description thereof will be omitted.

In step S1710, the content server 120 generates an HTTP response.

The generation of the HTTP response will be described in detail with reference to FIG. 17B.

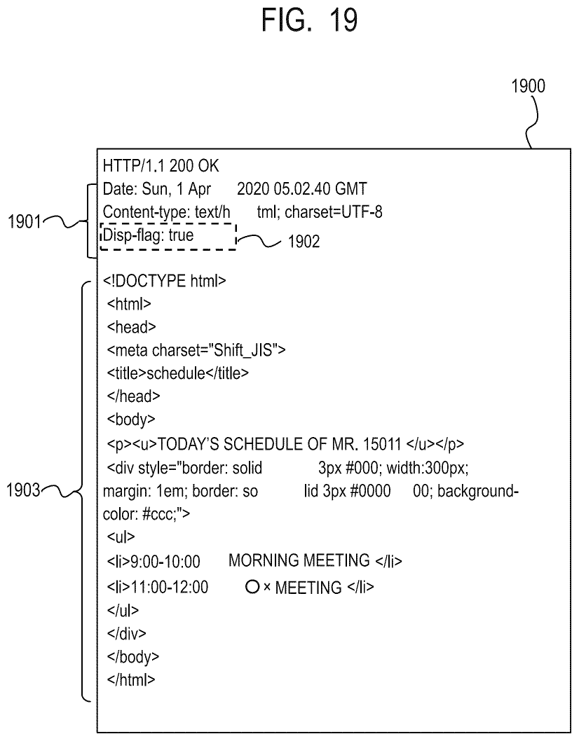

In step S1717 of FIG. 17B, the content server 120 acquires content corresponding to the content path 1502 of the content management table 1500 that is the information obtained in step S1709, and generates an HTTP response as shown in step S1900 of FIG. 19 using the acquired information. However, it is assumed that contents corresponding to the user attributes are not included at this time.

In step S1718, the content server 120 refers to the content management table 1500 to determine whether information of the requested content has been registered. FIG. 18 shows an example of the content management table 1500. Here, in step S1709 of FIG. 17A, it is assumed that the information of the HTTP request received in step S1708 has been registered in the row “No. 4” of the content management table 1500 as shown in FIG. 18.

In step S1718, it is determined whether the data corresponding to the content path 1502, the user name 1503, and domain name 1504 of the row “No. 4” was registered in the content management table 1500 shown in FIG. 18 before the date and time 1501 of the row “No. 4”. In the content management table 1500 of FIG. 18, the data of the row “No. 1” matches the data of the row “No. 4”, and it can be determined that the request has already been registered.

If the information of the requested content has already been registered in the content management table 1500 (Yes in step S1718), the content server 120 advances the process to step S1719.

In step S1719, the content server 120 sets “true” to the display flag in the header portion of the HTTP response. This HTTP response will be described with reference to FIG. 19.

In the HTTP response 1900 shown in FIG. 19, a Disp-Flag 1902 indicating the display flag is set in a header 1901. In step S1719, the content server 120 sets the Disp-Flag 1902 to “true” (“Disp-Flag: true”), and the process proceeds to step S1721.

If the information of the requested content has not yet been registered in the content management table 1500 (No in step S1718), the content server 120 advances the process to step S1720.

In step S1720, the content server 120 sets “false” or a blank in the display flag in the header portion of the HTTP response (“Disp-Flag: false” or “Disp-Flag:”), and the process proceeds to step S1721.

Note that steps S1721 to S1723 are same as steps S417 to S419 of FIG. 4E describing the first embodiment, and therefore description thereof will be omitted.

If the processing of FIG. 17B is completed, the CPU 201 advances the process to step S1711 of FIG. 17A.

The processes in steps S1711 and S1704 are the same as steps S410 and S404 in FIG. 4A describing the first embodiment, and therefore description thereof will be omitted.

Next, in step S1705, the CPU 201 analyzes the HTTP response. The analysis of the HTTP response will be described with reference to FIG. 17C.

In step S1724 of FIG. 17C, the CPU 201 analyzes a status, a header (the header 1901 in the example of FIG. 19), and body (a body 1903 in the example of FIG. 19) of the HTTP response.

Next, in step S1725, the CPU 201 acquires the Disp-Flag 1902 from the header 1901, and ends the processing of FIG. 17C.

If the processing of FIG. 17C is completed, the CPU 201 advances the process to step S1706 of FIG. 17A.

In step S1706, the CPU 201 determines whether the Disp-Flag 1902 acquired in step S1705 is set to “true” (“Disp-Flag: true”). If the Disp-Flag 1902 is set to “true” (Yes in step S1706), CPU 201 does not provide an instruction for displaying the content and ends the process of this flowchart.

If the Disp-Flag 1902 is not set to “true” (“Disp-Flag: false” or “Disp-Flag:”) (“No” in step S1706), the CPU 201 advances the process to step S1707.

In step S1707, the CPU 201 causes the signage application 300 to display the content corresponding to the HTTP response in the operation unit 209, and ends the process of this flowchart.

As described above, in the third embodiment, the display flag of the content is determined by the content server 120 and transmitted to the image processing apparatus 100, whereby the image processing apparatus 100 can determine whether the content should be displayed. As a result, for example, it is possible to control the signage application 300 not to display the content that has been already viewed once.

It should be noted that the Disp-Flag 1902 may be set to “true” not only if the data is registered or not, but also if it matches a specific condition. The specific condition could be a case that a number of registrations has reached a predetermined number of times.

If a certain period of time has passed since the Disp-Flag 1902 in a response to a first request was set to “true”, the Disp-Flag 1902 may be set to “false” in a response to a second request that matches the first request. An example of the above case is described with reference to the content management table 1500 shown in FIG. 18. If a request corresponding to the content path, the user name, and domain name included in the row “No. 1” is received again after a certain time has passed since a request corresponding the row “No. 4” was received, the Disp-Flag 1902 may be set to “false” in a response to the request.

It should be noted that “false” may be set in the Disp-Flag 1902 according to any other specific conditions.

### Fourth Embodiment

In the fourth embodiment, the image processing apparatus 100 determines whether the content has been viewed, and control the signage application 300 not to display the content once viewed.

If the image processing apparatus 100 receives an HTTP response from the content server 120 and the status of the HTTP response shows “OK”, the image processing apparatus 100 stores information of contents and a display flag (already viewed, “true”) in the content management table controlled by the image processing apparatus 100. Next, if a trigger for displaying a signage is issued in the image processing apparatus 100, it is determined whether the path acquired from the content setting management table 306 matches the information of content managed in the content management table of the image processing apparatus 100. If the path matches the information and the display flag shows “true”, the signage application 300 is controlled not to display the content again. Hereinafter, the above process will be described in detail with reference to some flowcharts.

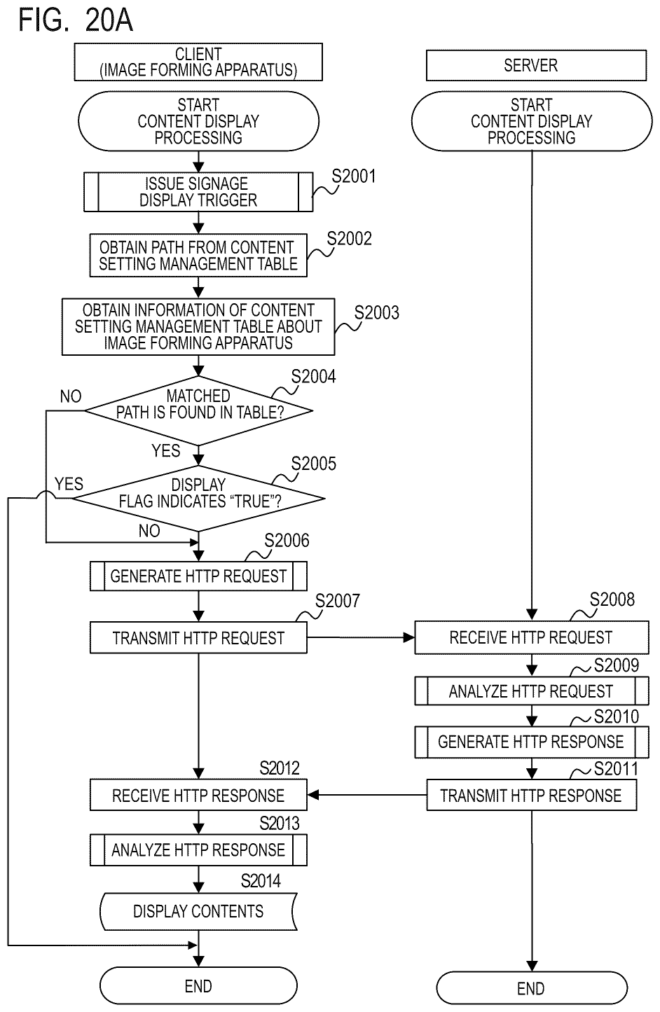

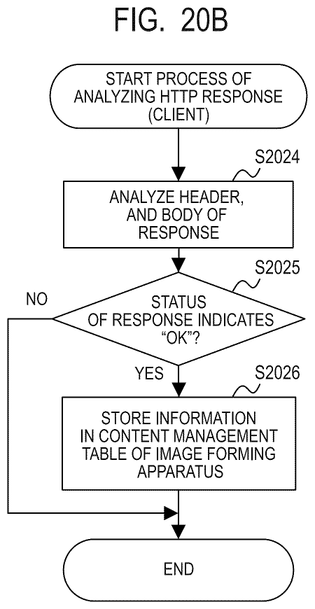

FIGS. 20A and 20B are flowcharts according to the fourth embodiment showing an example of a process in which the image processing apparatus 100 receives contents from the content server 120 and the signage application 300 controls content to be displayed. In the flow charts of the FIGS. 20A and 20B, the processing of the image processing apparatus 100 is implemented by the CPU 201 of the image processing apparatus 100 reading and executing a control program stored in the ROM 202 or the HDD 204. The processing of the content server 120 is implemented by a CPU of a computer (not shown) constituting the content server 120 that reads and executes a control program stored in a storage device such as an HDD.

FIG. 20A shows the overall process between the image processing apparatus 100 and the content server 120 for providing contents and for the signage application 300 controlling to display contents.

In step S2001, the CPU 201 of the image processing apparatus 100 issues a trigger for displaying Web contents. Since the process in step 2001 is same as that in FIG. 4B describing the first embodiment, description thereof will be omitted.

Next, in step S2002, the CPU 201 acquires the content paths 608, 618 or 628 corresponding to triggers for displaying a signage from the content setting management table 306. When the generation of the trigger for displaying a signage is caused by login, the content path 618 is acquired, if it is caused by the logout or auto-clear process, the content path 608 is acquired, and if it is caused by the print start process, the content path 628 is acquired.

Next, in step S2003, the CPU 201 refers to a content management table 2100 controlled by the image processing apparatus 100 to acquire information.

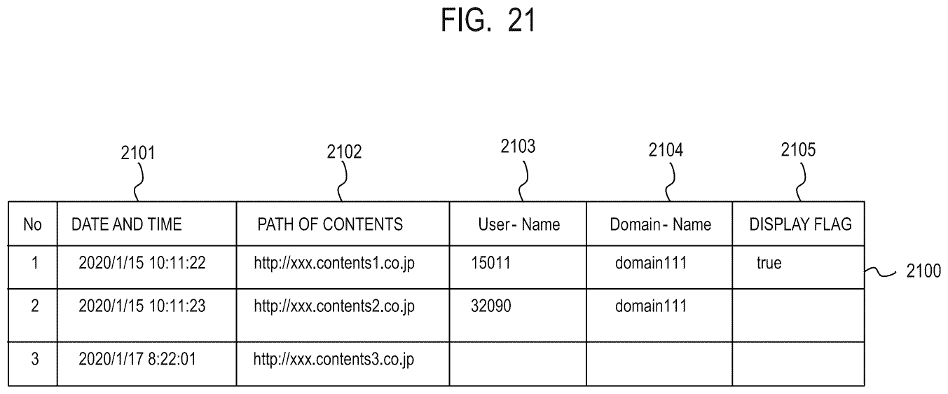

FIG. 21 is a diagram showing an example of the content management table 2100 controlled by the image processing apparatus 100 according to the fourth embodiment.

The content management table 2100 is a table for storing information of contents and information indicating whether the contents have been viewed if the status (1303 in the example of FIG. 13) of the HTTP response received from the content server 120 indicates “success” (i.e., “OK”).

In the content management table 2100, a “date and time” 2101 is an item for storing the date and time when the status of the response became successful (i.e., “OK”). A content path 2102 is an item for storing a path of the content displayed by the signage application 300. The content path 2102 stores paths corresponding to the content paths 608, 618 or 628 of the content setting management table 306. A user name 2103 and a domain name 2104 are items for storing a user name and a domain name of the user who is successfully authenticated by the image processing apparatus 100. A display flag 2105 is an item for setting whether the HTTP response has already been viewed or not if the status shows “success” (i.e., OK) when the HTTP response is received from the content server 120, and sets “true” if the HTTP response has been already been viewed. However, the setting of whether or not it has been viewed is not limited to the case where the status shows “success” (OK), and may be other conditions. For example, the display flag 2015 may be set to “true” if the status of “success” reaches a predetermined number of times or if a predetermined period of time has passed.

Next, in step S2004, the CPU 201 determines whether there is a path corresponding to the content path acquired in step S2002 in the content path 2102 of the content management table 2100 acquired in step S2003. If there is no such a path (No in step S2004), the CPU 201 advances the process to step S2006.

If there is a path corresponding to the content path acquired in step S2002 in the content path 2102 of the content management table 2100 acquired in step 2003 (YES in step S2004), the CPU 201 advances the process to step S2005.

In step S2005, the CPU 201 determines whether the display flag 2105 of the record determined to include a matched content path in step S2004 indicates “true”. For example, in the case of the row “No. 1” of the content management table 2100, the CPU 201 determines “Yes” as the display flag 2105 indicates “true”. In the case of the row “No. 2” in the content management table 2100, the CPU 201 determines “No” as the display flag 2105 indicates a blank.

If the display flag 2105 indicates “true” (Yes in step S2005), the CPU 201 does not display the contents in the signage application 300, and ends the process of this flowchart.

If the display flag 2105 indicates “false” or a blank (NO in step S2005), the CPU 201 advances the process to step S2006.

The processes in steps S2006, S2007, S2008 to S2011, and S2012 are same as steps S402, S403, S407 to S410, and S405 shown in FIG. 4A describing the first embodiment, and therefore descriptions therefor will not be omitted.

In step S2013, the CPU 201 analyzes the HTTP response using the signage application 300. The analysis of the HTTP response will be described with reference to FIG. 20B.

In step S2024 of FIG. 20B, the CPU 201 analyzes the status of the HTTP response (the status line 1301 in the example of FIG. 13), the contents of the header (the header 1304 in the example of FIG. 13), and the contents of the body (the body 1305, 1307 in the example of FIG. 13), and confirms the contents to be displayed.

Next, in step S2025, the CPU 201 checks whether the status of the HTTP response (1303 in the example of FIG. 13) indicates “OK”. If the status does not indicate “OK” (NO in step S2025), the CPU 201 terminates the process of FIG. 20B.

If the status indicates “OK” (“YES” in step S2025), the CPU 201 advances the process to step S2026.

In step S2026, the CPU 201 stores information of the contents and the display flag in the content management table 2100 of the image processing apparatus 100. For example, the date and time 2101, the content path 2102, the user name 2103, the domain name 2104, and the display flag 2105 are written to and stored in the row “No. 1” of the content management table 2100. The display flag 2105 is set to be “true” indicating that the document has been viewed. After step S2026, the CPU 201 terminates the process shown in FIG. 20B.

If the processing of FIG. 20B is completed, the CPU 201 advances the process to step S2014 of FIG. 4A.

In step S2014, the CPU 201 causes the signage application 300 to display the content corresponding to the HTTP response in the operation unit 209, and ends the process of this flowchart.

As described above, according to the fourth embodiment, the image processing apparatus 100 refers to the display flag of the content to determine whether the content should be displayed. As a result, for example, it is possible to control the signage application 300 not to display contents again if the contents have been viewed once.

The processing in the case where the content type is HTML has been described in the fourth embodiment. However, if the display flag is determined in the image processing apparatus 100, a content type may be other than HTML. In this case, the process in step S2025 of FIG. 20B may not be executed by using the status of the HTTP response, but executed by other ways to allow to determine that the display was successful. For example, if the setting parameters of the keys 604, 614, and 624 are set to SMB in the content setting management table 306, and a content path such as “jpg” is set to paths 605, 615, and 625. In this case, the image processing apparatus 100 may store “true” in the display flag 2105 of the content management table 2100 of the image processing apparatus 100 if the content can be acquired from the content paths inputted to paths 605, 615, 625. The above configuration allows to handle unlimited content types, manage the information about all the contents being already viewed or not, and control the signage application 300 to or not to display the contents.

According to the above embodiments, it is the operation unit 209 that displays the contents. However, if the user logs in to the image processing apparatus 100 from the client PC 102 and uses the remote desktop function, the content is displayed on the operation screen by the remote desktop.

Although the image processing apparatus 100 having multiple functions such as copy and scanner functions has been described as an example in the above embodiments, embodiments of the present disclosure are also applicable to an image processing apparatus (scanner device, facsimile machine, printer device, etc.) having only a part of the functions. Embodiments of the present disclosure are also applicable to other information processing devices such as personal computers, PDAs, cellular phones, cameras, video cameras, other image viewers, and various network appliances.

As described above, according to each of the embodiments, it is possible to specify a user who uses the image processing apparatus 100 or the like, obtain optimum contents from the content server 120 or the like depending on the users, and display the contents on the image processing apparatus 100 or the like. That is, even in an environment in which a single device such as an image processing apparatus is shared and used by multiple users, it is possible to realize a signage function for providing optimum contents depending on the users.

The configuration and the contents of the various data are not limited to the embodiments described above, but are configured in various forms and contents according to the purpose of use.

Although particular embodiments have been described above, embodiments of the present disclosure can be implemented as a system, apparatus, method, program, storage medium or the like. Specifically, embodiments of the present disclosure may be applied to a system comprising multiple devices, or may be also applied to a device comprising a single device.

Embodiments of the present disclosure also include a combination of the above embodiments.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure includes exemplary embodiments, it is to be understood that the disclosure is not limited to the disclosed exemplary embodiments. The scope of the following claims is to be accorded the broadest interpretation so as to encompass all such modifications and equivalent structures and functions.

What is claimed is:

1. An information processing apparatus operable to communicate with a server providing contents, the information processing apparatus comprising:
at least one processor; and
at least one memory coupled to the at least one processor and storing instructions, which when executed by the at least one processor, cause the at least one processor to act as:
a first setting unit configured to set timing of displaying contents;
a controller configured to:
transmit a request for the contents to the server;
receive the contents provided from the server based on the request; and
display the contents on an operation unit at the set timing; and
an identifying unit configured to identify a user operating the information processing apparatus,
wherein the controller is further configured to add information of the user identified by the identifying unit to the request, and
wherein the first setting unit is operable to set multiple timings for each of the contents to be displayed.

2. The information processing apparatus according to claim 1, wherein
the controller is further configured to receive contents based on the information of the user.

3. The information processing apparatus according to claim 1, wherein the instructions, when executed by the at least one processor, further cause the at least one processor to act as:
a second setting unit configured to set contents providable by the server in advance as contents to be displayed at the set timing,
wherein the controller is further configured to transmit a request for the contents set by the second setting unit.

4. The information processing apparatus according to claim 1, wherein
the controller is further configured to:
add the information of the user identified by the identifying unit to the request if the identifying unit succeeds in identifying the user; and
not add the information of the user to the request if the identifying unit fails in identifying the user.

5. The information processing apparatus according to claim 1, wherein the instructions, when executed by the at least one processor, further cause the at least one processor to act as:
a second setting unit configured to set restriction on notifying the server of information,
wherein, in a case that the restriction on the notification of the information is set by the second setting unit, the controller is further configured not to add the information of the user to the request even if the user operating the information processing apparatus is identified.

6. The information processing apparatus according to claim 1, wherein the instructions, when executed by the at least one processor, further cause the at least one processor to act as:
a management unit configured to manage information of contents displayed on the operation unit through the control by the controller,
wherein the controller is further configured not to transmit a request for the contents to the server if determined that contents to be displayed when a specific event has occurred satisfy a predetermined condition that is based on the management by the management unit.

7. The information processing apparatus according to claim 1, wherein
the server is configured to manage information of contents displayed by the information processing apparatus, and is operable to respond to the information processing apparatus with information indicating that the requested contents satisfy a predetermined condition that is based on the management if the requested contents satisfy the predetermined condition,
the controller is further configured not to display the contents if the information indicating that the requested contents satisfy the predetermined condition is received from the server as a response to the request.

8. The information processing apparatus according to claim 7, wherein
the predetermined condition is satisfied if the server stores information indicating that the information processing apparatus has displayed the contents.

9. The information processing apparatus according to claim 1, wherein
the set timing includes at least one of:
timing of the user logging in the information processing apparatus;
timing of the user logging out the information processing apparatus;
timing of initializing a setting parameter for a screen displayed on the operation unit to an initial value in response to no operation to the operation unit for a predetermined period of time; and
timing of starting printing based on a print job received under a status of displaying a print screen on the operation unit.

10. The information processing apparatus according to claim 1, wherein
the request is an HTTP request,
the controller is further configured to add the information of the user to a header of the HTTP request.

11. The information processing apparatus according to claim 1, wherein
the controller is further configured not to add the information of the user identified by the identifying unit to the request at timing of displaying a screen for user logout.

12. The information processing apparatus according to claim 1, wherein
the set timing is print execution timing.

13. The information processing apparatus according to claim 1, wherein
the request is sent when printing occurs.

14. A system including an information processing apparatus and a server providing contents for the information processing apparatus, the information processing apparatus and the server being operable to communicate with each other,
the information processing apparatus comprising:
first at least one processor; and
first at least one memory coupled to the first at least one processor and storing instructions, which when executed by the first at least one processor, cause the first at least one processor to act as:
a setting unit configured to set timing of displaying contents;
a controller configured to:
transmit a request for the contents to the server;
receive the contents provided from the server in response to the request; and
display the contents on an operation unit at the set timing; and
an identifying unit configured to identify a user operating the information processing apparatus,
the server comprising:
second at least one processor; and
second at least one memory coupled to the second at least one processor and storing instructions, which when executed by the second at least one processor, cause the second at least one processor to act as:
a provision unit configured to change the requested contents based on information of the user, and provide the changed contents for the information processing apparatus if the request includes information of the user identified as a user operating the information processing apparatus,
wherein the controller is further configured to:
add information of the user identified by the identifying unit to the request; and
receive contents that is based on the information of the user from the server, and
wherein the setting unit is operable to set multiple timings for each of the contents to be displayed.

15. A method for an information processing apparatus operable to communicate with a server providing contents, the method comprising:
setting timing of displaying contents;
transmitting a request for the contents to the server;
receiving the contents provided from the server in response to the request;
displaying the contents on an operation unit at the set timing;
identifying a user operating the information processing apparatus; and
adding information of the user identified in the identifying to the request,
wherein the setting includes setting multiple timings for each of the contents to be displayed.
